(19) United States
(12) Patent Application Publication
(10) Pub. No.: US 2025/0102869 A1
(43) Pub. Date: Mar. 27, 2025

(54) ARRAY SUBSTRATE AND LIQUID CRYSTAL DISPLAY DEVICE

(71) Applicant: Sharp Display Technology Corporation, Kameyama City (JP)

(72) Inventor: Katsunori MISAKI, Kameyama City (JP)

(21) Appl. No.: 18/795,947

(22) Filed: Aug. 6, 2024

(30) Foreign Application Priority Data
Sep. 25, 2023 (JP) 2023-159986

(51) Int. Cl. G02F 1/1362; G02F 1/1337

(52) U.S. Cl. CPC G02F 1/136209; G02F 1/1337

(57) ABSTRACT

An array substrate includes a first electrode, a first insulating film disposed on an upper layer side of the first electrode, the first insulating film being provided with an opening at a position overlapping at least the first electrode, a second electrode disposed on an upper layer side of the first insulating film, the second electrode overlapping the first electrode at least in the opening, and being connected to the first electrode, a second insulating film disposed on an upper layer side of the second electrode, and an alignment film disposed on an upper layer side than the second insulating film. The second insulating film includes an insulating portion provided in the opening, and the insulating portion includes a high level portion higher than an opening edge of the opening of the first insulating film.

### CROSS-REFERENCE TO RELATED APPLICATIONS

This application claims the benefit of priority to Japanese Patent Application Number 2023-159986 filed on Sep. 25, 2023. The entire contents of the above-identified application are hereby incorporated by reference.

### BACKGROUND

### Technical Field

The techniques disclosed herein relate to array substrates and liquid crystal display devices.

As an example of a liquid crystal display device in the related art, there is known a liquid crystal display device described in JP 2021-26039 A. The liquid crystal display device described in JP 2021-26039 A includes a switching element disposed in a display region including pixels, a color filter layer including a first color filter of a first color and a second color filter of a second color different from the first color, and a conductive layer connected to the switching element through a contact hole penetrating the color filter layer. The conductive layer is in contact with the first color filter and the second color filter in the contact hole.

### SUMMARY

JP 2021-26039 A mentioned above discloses a configuration in which a black layer is disposed in an interior of a contact hole, and light incident on a region where a color filter layer is removed in the contact hole is blocked by the black layer and color mixing can be suppressed. However, in JP 2021-26039 A, the black layer is formed flush with an insulating layer in a periphery of the contact hole. Thus, when an alignment film is formed on the upper layer side than the insulating layer in a manufacturing process, a situation is likely to occur in which a material of the alignment film accumulates on the black layer. When the material of the alignment film accumulates on the black layer, the material of the alignment film may cause insufficiency at a position other than a position on the black layer, and thus the film thickness of the alignment film may be locally thin, or the alignment film may be locally not formed. When a thin film location or a not formed location is present in the alignment film, an alignment of the liquid crystal is disturbed near the location, and as a result, a display defect may be visually recognized.

The techniques described herein have been made based on the circumstances described above, and an object thereof is to suppress film thickness unevenness of an alignment film.

(1) An array substrate according to the techniques described in the present specification includes a first electrode, a first insulating film disposed on an upper layer side of the first electrode, the first insulating film being provided with an opening at a position overlapping at least the first electrode, a second electrode disposed on an upper layer side of the first insulating film, the second electrode overlapping the first electrode at least in the opening, and being connected to the first electrode, a second insulating film disposed on an upper layer side of the second electrode, and an alignment film disposed on an upper layer side than the second insulating film. The second insulating film includes an insulating portion provided in the opening, and the insulating portion includes a high level portion higher than an opening edge of the opening of the first insulating film.

(2) In addition to (1), in the array substrate, the first electrode and the second electrode include a plurality of first electrodes and a plurality of second electrodes disposed side by side at intervals in a first direction, and each of the opening and the insulating portion extends along the first direction and is disposed to cross the plurality of first electrodes and the plurality of second electrodes.

(3) In addition to (2), the array substrate may further include a first light blocking portion disposed on a lower layer side than the first electrode and made of a light blocking material, and the first light blocking portion may extend along the first direction and may be disposed overlapping the insulating portion.

(4) In addition to (2), the array substrate may further include a plurality of second light blocking portions disposed on a lower layer side of the alignment film, the second light blocking portions being made of a light blocking material, wherein the plurality of second light blocking portions are disposed side by side at intervals to interpose the first electrode and the second electrode in the first direction, and the high level portion is disposed to be interposed between two of the second light blocking portions in the first direction.

(5) In addition to any one of (1) to (4), in the array substrate, a height of the high level portion from the opening edge of the opening of the first insulating film may be larger than a film thickness of the alignment film.

(6) In addition to any one of (1) to (4), in the array substrate, a height of the high level portion from the opening edge of the opening of the first insulating film may be smaller than a film thickness of the alignment film.

(7) In addition to any one of (1) to (6), in the array substrate, the high level portion may be configured to be gradually higher from an outer peripheral end side toward a center side of the insulating portion.

(8) In addition to any of (1) to (6), in the array substrate, an upper face of the high level portion may be a plane.

(9) In addition to any one of (1) to (6), the array substrate the high level portion may be configured to be gradually lower from an outer peripheral end side toward a center side of the insulating portion.

(10) A liquid crystal display device according to the techniques described in the present specification includes the array substrate described in any one of the above-described (1) to (9), a counter substrate disposed to face the array substrate, and a liquid crystal layer disposed between the array substrate and the counter substrate.

(11) In addition to (10), in the liquid crystal display device, the counter substrate is provided with a spacer protruding toward the array substrate, the first electrode and the second electrode include a plurality of first electrodes and a plurality of second electrodes disposed side by side at intervals in a first direction, each of the opening and the insulating portion extends in the first direction and is disposed to cross the plurality of first electrodes and the plurality of second electrodes, and the insulating portion includes a bump higher than the opening edge of the opening of the first insulating film and disposed overlapping the spacer.

(12) In addition to (11), in the liquid crystal display device, the high level portion may be lower than the bump.

According to the techniques described in the present specification, film thickness unevenness of an alignment film can be suppressed.

### BRIEF DESCRIPTION OF DRAWINGS

The disclosure will be described with reference to the accompanying drawings, wherein like numbers reference like elements.

FIG. 1 is a schematic perspective view illustrating a state in which a head-mounted display according to a first embodiment is worn on the head by a user.

FIG. 2 is a schematic side view illustrating an optical relationship between a liquid crystal display device and a lens unit provided in a head-mounted device included in the head-mounted display according to the first embodiment, and an eyeball of the user.

FIG. 3 is a schematic plan view illustrating a liquid crystal panel and a flexible substrate provided in the liquid crystal display device according to the first embodiment.

FIG. 4 is a schematic cross-sectional view of the liquid crystal panel according to the first embodiment.

FIG. 5 is a plan view illustrating a pixel arrangement in a display region of an array substrate provided in the liquid crystal panel according to the first embodiment.

FIG. 6 is a cross-sectional view of the liquid crystal panel according to the first embodiment taken along a line vi-vi in FIG. 5.

FIG. 7 is a cross-sectional view of the liquid crystal panel according to the first embodiment taken along a line vii-vii in FIG. 5.

FIG. 8 is a cross-sectional view of the liquid crystal panel according to the first embodiment taken along a line viii-viii in FIG. 5.

FIG. 9 is a plan view illustrating a pixel in a display region of the liquid crystal panel according to the first embodiment, and indicating a first metal film and a fourth metal film with shading.

FIG. 10 is a plan view illustrating a pixel in a display region of the liquid crystal panel according to the first embodiment, and indicating a semiconductor film and a second metal film with shading.

FIG. 11 is a plan view illustrating a pixel in a display region of the liquid crystal panel according to the first embodiment, and indicating a first transparent electrode film, a semiconductor film, a second transparent electrode film, and a third transparent electrode film with shading.

FIG. 12 is a cross-sectional view of the liquid crystal panel according to the first embodiment taken along a line xii-xii in FIG. 5.

FIG. 13 is a cross-sectional view of the liquid crystal panel according to the first embodiment taken along a line xiii-xiii in FIG. 5.

FIG. 14 is a cross-sectional view illustrating a state in which a second flattening film is formed in a thirteenth step included in the array substrate manufacturing step according to the first embodiment, and illustrating a cross-sectional structure at the same cutting position as in FIG. 7 and a cross-sectional structure at the same cutting position as in FIG. 12.

FIG. 15 is a cross-sectional view illustrating a state in which the second flattening film is exposed through a photomask in the thirteenth step included in the array substrate manufacturing step according to the first embodiment, and illustrating the cross-sectional structure at the same cutting position as in FIG. 7 and the cross-sectional structure at the same cutting position as in FIG. 12.

FIG. 16 is a cross-sectional view illustrating a state in which the second flattening film is developed in the thirteenth step included in the array substrate manufacturing step according to the first embodiment, and illustrating the cross-sectional structure at the same cutting position as in FIG. 7 and the cross-sectional structure at the same cutting position as in FIG. 12.

FIG. 17 is a cross-sectional view illustrating a cross-sectional structure at the same cutting position as in FIG. 12 in the liquid crystal panel according to a second embodiment.

FIG. 18 is a cross-sectional view illustrating a cross-sectional structure at the same cutting position as in FIG. 13 in the liquid crystal panel according to the second embodiment.

FIG. 19 is a cross-sectional view illustrating a state in which the second flattening film is exposed through the photomask in the thirteenth step included in the array substrate manufacturing step according to the second embodiment, and illustrating the cross-sectional structure at the same cutting position as in FIG. 12.

FIG. 20 is a cross-sectional view illustrating a cross-sectional structure at the same cutting position as in FIG. 12 in the liquid crystal panel according to a third embodiment.

FIG. 21 is a cross-sectional view illustrating a cross-sectional structure at the same cutting position as in FIG. 13 in the liquid crystal panel according to the third embodiment.

FIG. 22 is a cross-sectional view illustrating a state in which the second flattening film is exposed through the photomask in the thirteenth step included in the array substrate manufacturing step according to the third embodiment, and illustrating the cross-sectional structure at the same cutting position as in FIG. 12.

FIG. 23 is a cross-sectional view illustrating a cross-sectional structure at the same cutting position as in FIG. 12 in the liquid crystal panel according to a fourth embodiment.

FIG. 24 is a cross-sectional view illustrating a cross-sectional structure at the same cutting position as in FIG. 13 in the liquid crystal panel according to the fourth embodiment.

FIG. 25 is a cross-sectional view illustrating a state in which the second flattening film is exposed through the photomask in the thirteenth step included in the array substrate manufacturing step according to the fourth embodiment, and illustrating the cross-sectional structure at the same cutting position as in FIG. 12.

FIG. 26 is a cross-sectional view illustrating a cross-sectional structure at the same cutting position as in FIG. 12 in the liquid crystal panel according to a fifth embodiment.

FIG. 27 is a cross-sectional view illustrating a cross-sectional structure at the same cutting position as in FIG. 13 in the liquid crystal panel according to the fifth embodiment.

FIG. 28 is a cross-sectional view illustrating a state in which a second flattening film is exposed through a photomask in the thirteenth step included in the array substrate manufacturing step according to the fifth embodiment, and illustrating the cross-sectional structure at the same cutting position as in FIG. 12.

FIG. 29 is a cross-sectional view illustrating a cross-sectional structure at the same cutting position as in FIG. 12 in the liquid crystal panel according to a sixth embodiment.

FIG. 30 is a cross-sectional view illustrating a cross-sectional structure at the same cutting position as in FIG. 13 in the liquid crystal panel according to the sixth embodiment.

FIG. 31 is a cross-sectional view illustrating a state in which the second flattening film is exposed through the photomask in the thirteenth step included in the array substrate manufacturing step according to the sixth embodiment, and illustrating the cross-sectional structure at the same cutting position as in FIG. 12.

### DESCRIPTION OF EMBODIMENTS

### First Embodiment

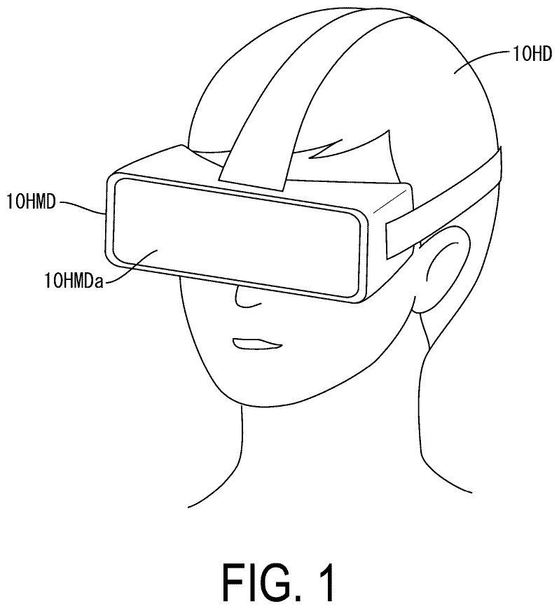

A first embodiment will be described with reference to FIGS. 1 to 16. In the present embodiment, a goggle-type head-mounted display (Head-Mounted Display: HMD) 10HMD and a liquid crystal display device 10 used for the head-mounted display are exemplified. Note that some drawings show an X-axis, a Y-axis, and a Z-axis, and directions of these axes are drawn so as to be common in all the drawings.

The appearance of the goggle-type head-mounted display 10HMD will be described with reference to FIG. 1. As illustrated in FIG. 1, the head-mounted display 10HMD includes a head-mounted device 10HMDa mounted on the head 10HD of the user. The head-mounted device 10HMDa surrounds both eyes of the user.

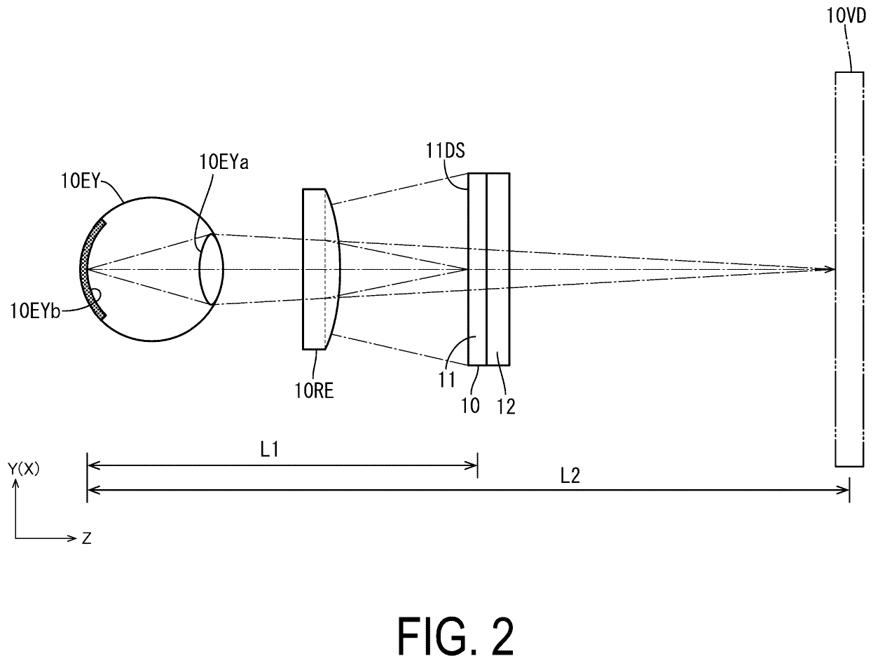

A configuration of the head-mounted device 10HMDa will be described with reference to FIG. 2. As illustrated in FIG. 2, the head-mounted device 10HMDa incorporates at least a liquid crystal display device 10 displaying an image and a lens unit 10RE focusing the image displayed on the liquid crystal display device 10 on an eyeball 10EY of the user. The liquid crystal display device 10 includes at least a liquid crystal panel (display device) 11 and a backlight device (illumination device) 12 irradiating the liquid crystal panel 11 with light. A main surface of the liquid crystal panel 11 on the lens unit 10RE side is a display surface 11DS displaying the image. The lens unit 10RE is disposed to be interposed between the liquid crystal display device 10 and the eyeball 10EY of the user. The lens unit 10RE imparts a refracting action to light. By adjusting the focal length of the lens unit 10RE, the user can recognize that an image focused on a retina 10EYb through a crystalline lens 10EYa of the eyeball 10EY is displayed on a virtual display 10VD that is apparently present at a position of a distance L2 from the eyeball 10EY. This distance L2 is much larger than an actual distance L1 from the eyeball 10EY to the liquid crystal display device 10. As a result, the user can visually recognize an enlarged image that is a virtual image displayed on the virtual display 10VD having a screen size (for example, from about several tens of inches to about several hundreds of inches) much larger than a screen size (for example, from about 0. several inches to about several inches) of the liquid crystal display device 10.

By mounting one liquid crystal display device 10 on the head-mounted device 10HMDa an image for a right eye and an image for a left eye can be displayed on the liquid crystal display device 10. Alternatively, by mounting two liquid crystal display devices 10 on the head-mounted device 10HMDa, the image for the right eye and the image for the left eye may be displayed on one of the liquid crystal display devices 10 and on the other of the liquid crystal display devices 10, respectively. The head-mounted device 10HMDa may be provided with earphones or the like that are addressed to the ears of the user and emit a sound.

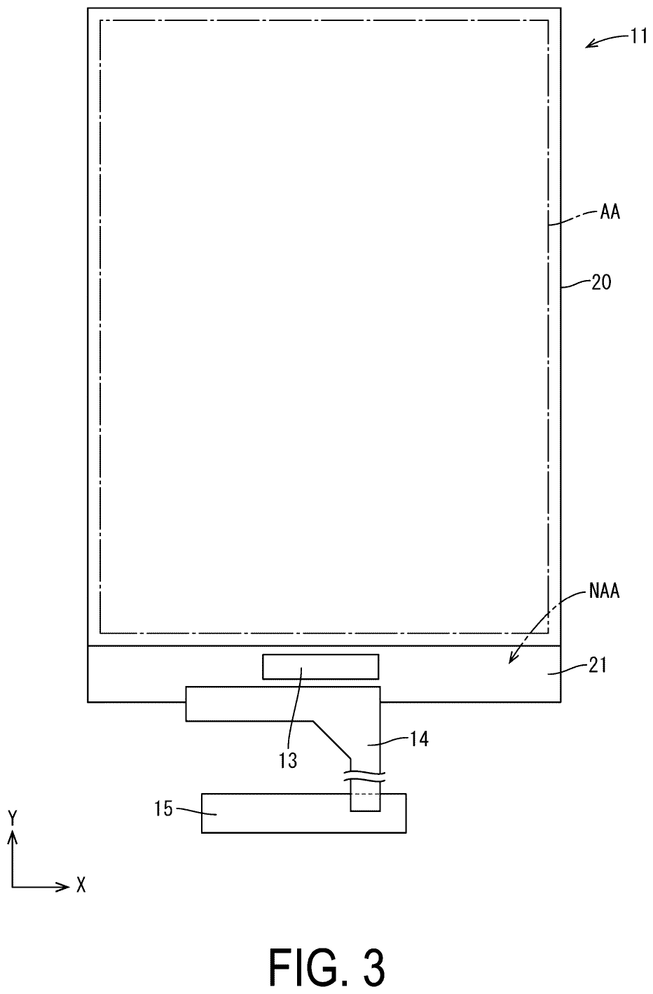

A configuration of the liquid crystal panel 11 included in the liquid crystal display device 10 will be described with reference to FIG. 3 and the like. Note that the configuration of the backlight device 12 is as known, and includes, for example, a light source such as an LED, an optical member that converts light from the light source into planar light by applying an optical effect to the light from the light source, and the like. As illustrated in FIG. 3, the liquid crystal panel 11 has a rectangular shape as a whole in plan view. A center-side portion of the screen of the liquid crystal panel 11 is a display region AA in which an image is displayed. A frame-shaped outer peripheral portion surrounding the display region AA of the screen of the liquid crystal panel 11 is a non-display region NAA in which no image is displayed. A range surrounded by an alternating dotted-dashed line in FIG. 3 is the display region AA. The liquid crystal panel 11 according to the present embodiment is used in the head-mounted display 10HMD described above and thus has an extremely high resolution, with a pixel density thereof being, for example, about 1000 ppi or more.

As illustrated in FIG. 3, the liquid crystal panel 11 is formed by bonding a pair of substrates 20 and 21 together. Of the pair of substrates 20 and 21, one disposed on a front side is a counter substrate (second substrate, CF substrate) 20, and the other one disposed on a back side is an array substrate (first substrate, active matrix substrate) 21. The counter substrate 20 and the array substrate 21 are each formed by layering various films on an inner face side of a respective one of glass substrates 20GS and 21GS that are substantially transparent and have excellent light-transmittance. The substrates 20GS and 21GS contain, for example, alkali-free glass as a main material. The array substrate 21 is larger than the counter substrate 20, and part of the array substrate 21 protrudes laterally with respect to the counter substrate 20. A driver 13 for performing display driving and the flexible substrate 14 are mounted (connected) on a protruding portion 21A of the array substrate 21 with an anisotropic conductive film (ACF) interposed therebetween. The flexible substrate 14 has a configuration in which a plurality of wiring line patterns are formed on a flexible base material having insulating properties. A control circuit board (signal supply source) 15 that supplies various input signals from the outside to the driver 13 is connected to the flexible substrate 14.

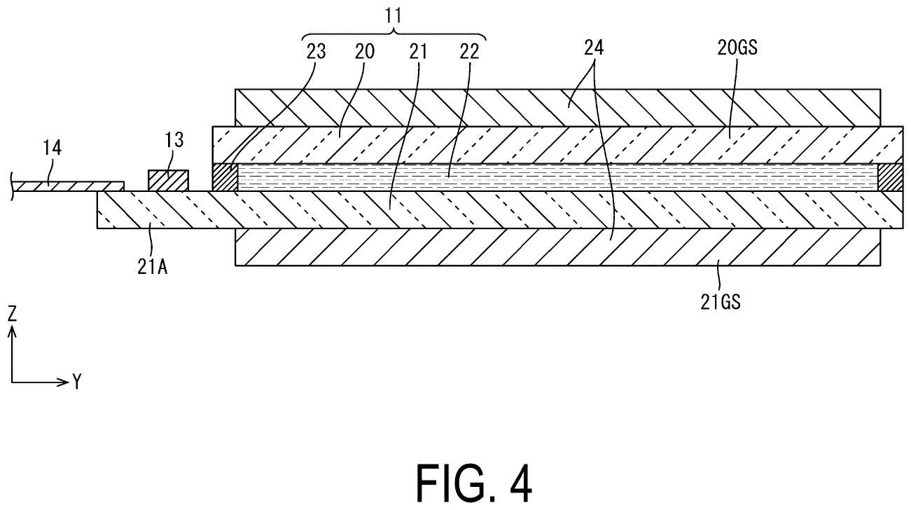

Next, a schematic cross-sectional configuration of the liquid crystal panel 11 will be described with reference to FIG. 4. As illustrated in FIG. 4, the pair of substrates 20 and 21 are disposed to face each other at intervals in the Z-axis direction that is the normal direction of main surfaces of the substrates 20 and 21. At least a liquid crystal layer 22 and a sealing portion 23 sealing the liquid crystal layer 22 are each interposed between the pair of substrates 20 and 21. The liquid crystal layer 22 contains liquid crystal molecules that are a substance having optical characteristics changing according to an applied electrical field. The sealing portion 23 has a rectangular frame-like shape (endless ring shape) as a whole in plan view, and surrounds over the entire periphery of the liquid crystal layer 22 in the non-display region NAA. A gap (cell gap) corresponding to the thickness of the liquid crystal layer 22 is maintained by the sealing portion 23. Note that polarizers 24 are bonded to outer face sides of the pair of substrates 20 and 21, respectively.

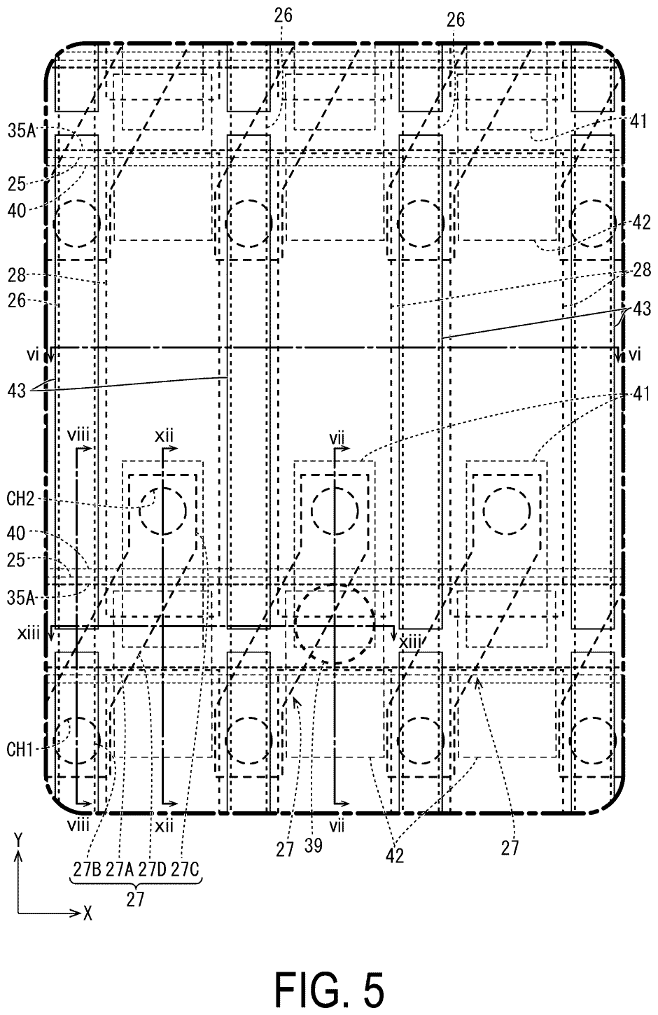

An overview of a pixel arrangement in the display region AA of the array substrate 21 will now be described with reference to FIG. 5. A plurality of gate wiring lines (scanning wiring lines) 25 and a plurality of source wiring lines (image wiring lines) 26 forming a lattice pattern are disposed on an inner face side of the display region AA of the array substrate 21 as illustrated in FIG. 5. Each of the gate wiring lines 25 extends in the X-axis direction to cross the display region AA. The plurality of gate wiring lines 25 are arranged side by side at intervals in the Y-axis direction. Each of the source wiring lines 26 extends in the Y-axis direction to cross the display region AA, and is substantially orthogonal to (intersects) the plurality of gate wiring lines 25. The plurality of source wiring lines 26 are arranged at intervals in the X-axis direction. A TFT (switching element) 27 and a pixel electrode (third electrode) 28 are each provided near an intersection of the gate wiring line 25 and the source wiring line 26. A plurality of the TFTs 27 and a plurality of the pixel electrode 28 are arranged regularly in the X-axis direction and the Y-axis direction. The gate wiring line 25, the source wiring line 26, and the pixel electrode 28 are connected to the TFT 27. The TFT 27 includes a gate electrode 27A to which the gate wiring line 25 is connected, a source electrode 27B to which the source wiring line 26 is connected, a drain electrode 27C to which the pixel electrode 28 is connected, and a semiconductor portion 27D connected to the source electrode 27B and the drain electrode 27C. The semiconductor portion 27D is made of a semiconductor material and is disposed overlapping the gate electrode 27A. When the TFT 27 is driven based on the scanning signal supplied from the gate wiring line 25 to the gate electrode 27A, the TFT 27 charges the pixel electrode 28 to a potential based on the image signal supplied from the source wiring line 26 to the source electrode 27B. The pixel electrode 28 forms an elongated shape with a longitudinal direction matching the Y-axis direction.

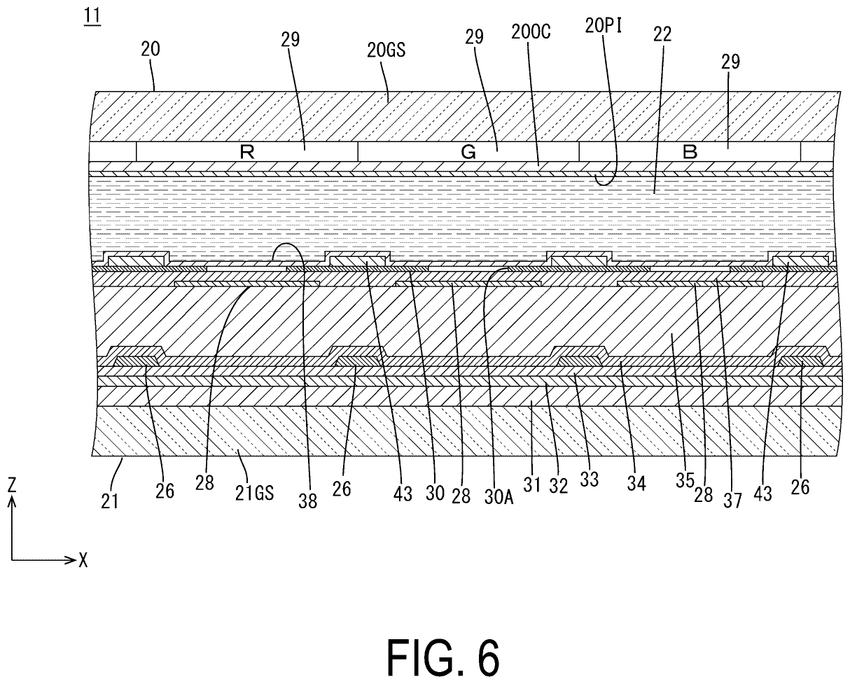

A common electrode 30 is provided on the inner face side of the display region AA of the array substrate 21, as illustrated in FIG. 6. The common electrode 30 is located on the upper layer side than the pixel electrode 28, and is disposed over substantially the entire display region AA. As a result, the common electrode 30 overlaps the pixel electrode 28 disposed in the display region AA. As described above, in the array substrate 21 according to the present embodiment, the “upper layer electrode” that is the electrode among the pixel electrode 28 and the common electrode 30 located on the upper layer side is the common electrode 30, and the “lower layer electrode” that is the electrode located on the lower layer side is the pixel electrode 28. A plurality of slits 30A are each formed open in a respective one of portions of the common electrodes 30 each overlapping a respective one of the plurality of pixel electrodes 28. A common potential signal that is a common potential (reference potential) is supplied to the common electrode 30. When the pixel electrode 28 is charged to a potential based on the image signal transmitted to the source wiring line 26 according to driving of the TFT 27, a potential difference is generated between the pixel electrode 28 and the common electrode 30. Then, a fringe electrical field (oblique electrical field) including a component in a normal direction with respect to a main surface of the array substrate 21 in addition to a component along the main surface of the array substrate 21 is generated between an opening edge of the slit 30A in the common electrode 30 and the pixel electrode 28. Accordingly, by using this fringe electrical field, it is possible to control the alignment state of the liquid crystal molecules included in the liquid crystal layer 22, and a predetermined display is formed based on the alignment state of the liquid crystal molecules. That is, the operation mode of the liquid crystal panel 11 according to the present embodiment is a fringe field switching (FFS) mode.

Subsequently, the various films layered on the glass substrate 21GS of the array substrate 21 will be described in detail with reference to FIGS. 6 to 8. As illustrated in FIGS. 6 to 8, at least a first metal film, a base coat film 31, a semiconductor film, a gate insulating film 32, a second metal film, a first interlayer insulating film 33, a third metal film, a second interlayer insulating film 34, a first transparent electrode film, a first flattening film (first insulating film) 35, a second transparent electrode film, a second flattening film (second insulating film) 36, a third transparent electrode film, a third interlayer insulating film 37, a fourth transparent electrode film, a light blocking film, and an alignment film 38 are layered on the glass substrate 21GS of the array substrate 21 in this order from the lower layer side (glass substrate 21GS side).

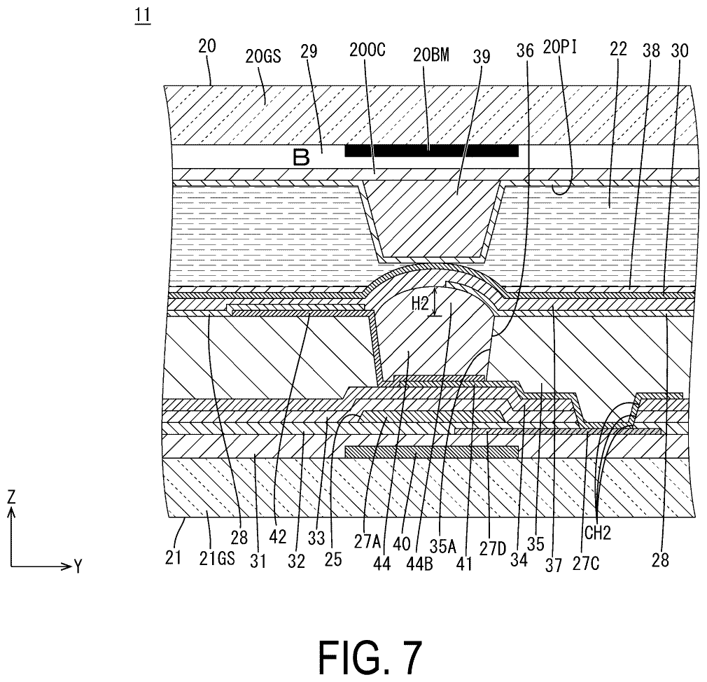

Each of the first metal film, the second metal film, and the third metal film is a single-layer film made of one type of metal material or a layered film or alloy made of different types of metal materials, and thus has conductivity and light-blocking properties. As illustrated in FIG. 7, among them, the first metal film constitutes a first light blocking portion 40. The first light blocking portion 40 is disposed at a position overlapping the semiconductor portion 27D of the TFT 27, and thus can block light traveling from the backlight device 12 to the semiconductor portion 27D. This can suppress a variation in the characteristics of the TFT 27 that may occur when the semiconductor portion 27D is irradiated with light. The second metal film constitutes the gate wiring line 25 and the gate electrode 27A. A portion of the gate wiring line 25 overlapping the semiconductor portion 27D in plan view serve as the gate electrode 27A. As illustrated in FIG. 6, the third metal film constitutes the source wiring line 26.

The first transparent electrode film, the second transparent electrode film, the third transparent electrode film, and the fourth transparent electrode film are made of a transparent electrode material such as indium tin oxide (ITO), indium zinc oxide (IZO), or the like. As illustrated in FIG. 7, among them, the first transparent electrode film constitutes a first electrode 41. One end side portion of the first electrode 41 is connected to the drain electrode 27C. The second transparent electrode film constitutes a second electrode 42. The second electrode 42 has one end side portion connected to the other end side portion of the first electrode 41, and has the other end side portion connected to the pixel electrode 28. The drain electrode 27C and the pixel electrode 28 are connected to each other by the first electrode 41 and the second electrode 42. The third transparent electrode film constitutes the pixel electrode 28. The fourth transparent electrode film constitutes the common electrode 30.

The semiconductor film is made of an oxide semiconductor material. Specifically, the semiconductor film includes, for example, an oxide semiconductor thin film containing indium (In), gallium (Ga), and zinc (Zn) being a kind of oxide semiconductor. The oxide thin film containing indium (In), gallium (Ga), and zinc (Zn) is amorphous or crystalline. The oxide semiconductor material of the semiconductor film has characteristics of higher resistance value in a state in which no voltage is applied (off state) than the silicon semiconductor material. The oxide semiconductor material of the semiconductor film has higher electron mobility than an amorphous silicon semiconductor material.

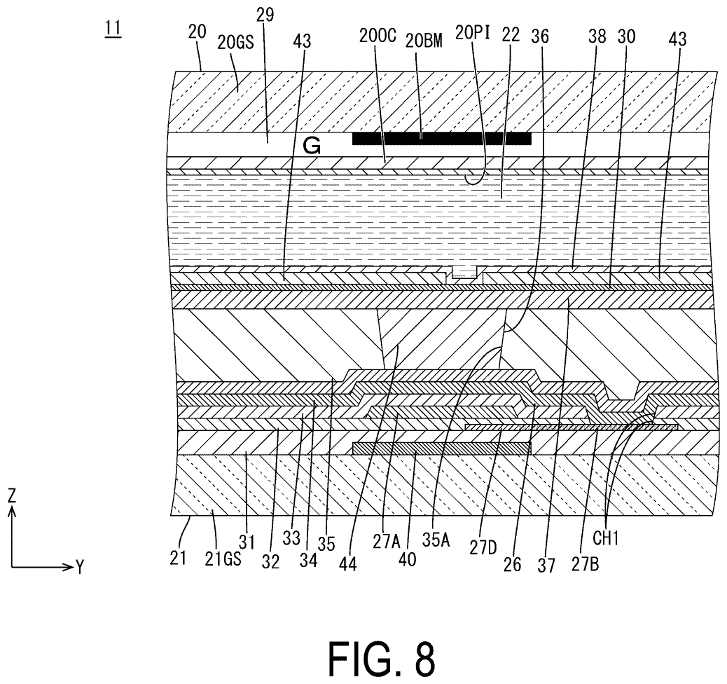

The semiconductor film according to the present embodiment is subjected to a resistance reducing process, in the manufacturing process, to include a part having a reduced resistance, thus including a reduced resistance region and a non-reduced resistance region. Note that, in FIG. 7 and the like, the reduced resistance region of the semiconductor film is illustrated with shading. The non-reduced resistance region of the semiconductor film is capable of charge transfer only under specific conditions (when a scanning signal is supplied to the gate electrode 27A). The non-reduced resistance region of the semiconductor film constitutes the semiconductor portion 27D. The semiconductor portion 27D is a portion of the semiconductor film overlapping the gate electrode 27A in plan view. The reduced resistance region of the semiconductor film has an extremely low resistivity of, for example, about 1/10000000000 to 1/100 compared to the non-reduced resistance region, and because charges can constantly move, functions as a conductor. As illustrated in FIG. 7 and FIG. 8, the reduced resistance region of the semiconductor film constitutes the source electrode 27B and the drain electrode 27C. The resistance reducing process for the semiconductor film is, in a manufacturing process for the array substrate 21, performed by forming the gate wiring line 25 and the gate electrode 27A including the second metal film and then using the gate wiring line 25 and the gate electrode 27A as a mask. The resistance reducing process is selectively performed on the portions (non-overlapping portions, exposed portions) of the semiconductor film not covered with the gate wiring line 25 and the gate electrode 27A, and is not performed on the portions (overlapping portions, unexposed portions) covered with the gate wiring line 25 and the gate electrode 27A. The resistance reducing process includes, for example, a plasma process or an annealing process using a gas such as NH₃, H₂, N₂, or He.

The base coat film 31, the gate insulating film 32, the first interlayer insulating film 33, the second interlayer insulating film 34, and the third interlayer insulating film 37, are each made of silicon oxide (SiO₂), silicon nitride (SiNₓ), or the like that are a kind of inorganic material (inorganic resin material). Among them, the base coat film 31 is interposed between the first light blocking portion 40 and the gate wiring line 25 and the gate electrode 27A to keep them in an insulating state. The gate insulating film 32 is interposed between the gate wiring line 25 and the gate electrode 27A and the source electrode 27B, the drain electrode 27C, and the semiconductor portion 27D to keep them in an insulating state. The first interlayer insulating film 33 is interposed between the gate wiring line 25 and the source wiring line 26 to keep them in an insulating state. The second interlayer insulating film 34 is interposed between the source wiring line 26 and the first electrode 41 to keep them in an insulating state. The third interlayer insulating film 37 is interposed between the pixel electrode 28 and the common electrode 30 to keep them in an insulating state.

The first flattening film 35 and the second flattening film 36 are each made of PMMA (acrylic resin), which is a kind of organic material (organic resin material), or the like. The first flattening film 35 and the second flattening film 36 made of the organic material each usually have a larger film thickness than the base coat film 31, the gate insulating film 32, the first interlayer insulating film 33, the second interlayer insulating film 34, and the third interlayer insulating film 37, each made of the inorganic material. Specifically, the film thickness of each of the base coat film 31, the gate insulating film 32, the first interlayer insulating film 33, the second interlayer insulating film 34, and the third interlayer insulating film 37 each made of the inorganic material is, for example, from about several tens nm to about several hundreds nm, whereas the film thickness of each of the first flattening film 35 and the second flattening film 36 made of the organic material is, for example, from about 1 μm to about 3 μm. The first flattening film 35 is interposed between the first electrode 41 and the second electrode 42. The second flattening film 36 is interposed between the second electrode 42 and the pixel electrode 28.

The light blocking film may have a layered structure including, for example, a light blocking layer made of a metal material, a reflection/transmission layer made of a metal material, and a transmission layer made of a light-transmitting resin material. Specifically, the light blocking film includes the light blocking layer made of, for example, molybdenum (Mo), the first transmission layer made of, for example, SiNₓ, the reflection/transmission layer made of, for example, Mo and having a film thickness smaller than that of the light blocking layer, and the second transmission layer made of, for example, SiNₓ in this order from the lower layer side. The light blocking layer has a function of blocking light emitted from the backlight device 12. A film thickness of the light blocking layer is preferably, for example, 30 nm or more in order to exhibit the above-described light blocking function. The first transmission layer has a function of reducing reflection of external light by using thin film interference. A film thickness of the first transmission layer is preferably in the range, for example, from 20 nm to 100 nm in order to exhibit the above-described external light reflection reducing function. The reflection/transmission layer has a function of reducing reflection of external light and a function of re-reflecting light reflected by the light blocking layer. A film thickness of the reflection/transmission layer is preferably in the range, for example, from 3 nm to 20 nm in order to exhibit the above-described functions. The second transmission layer has a function of reducing reflection of external light by using thin film interference. A film thickness of the second transmission layer is smaller than the film thickness of the first transmission layer. The light blocking film having such a configuration constitutes a second light blocking portion 43. The light blocking film may have a single-layer structure or a layered structure made of a metal material having light-blocking properties in addition to the above, or may have a single-layer structure or a layered structure made of a light blocking resin material.

The alignment film 38 is made of an organic material such as polyimide, for example. The alignment film 38 includes an upper face, facing the liquid crystal layer 22, subjected to optical alignment treatment, and thus has a function of aligning liquid crystal molecules. A film thickness of the alignment film 38 is, for example, from about several tens nm to about several hundreds nm.

On the other hand, as illustrated in FIG. 6 and FIG. 7, on the glass substrate 20GS of the counter substrate 20, a color filter 29, a counter-side light blocking portion 20BM, an overcoat film 200C, a spacer 39, and a counter-side alignment film 20PI are formed. The color filter 29 is disposed overlapping the pixel electrode 28 of the array substrate 21 and, together with the overlapping pixel electrode 28, constitutes a pixel, which is a unit of display. The color filter 29 includes a plurality of types (three types) exhibiting colors different from each other. The plurality of types of color filters 29 exhibiting colors different from each other are arranged side by side so as to be adjacent to each other in the extension direction of the gate wiring line 25 (X-axis direction). Thus, the arrangement direction of the plurality of types of color filters 29 exhibiting colors different from each other matches the X-axis direction. The plurality of types of color filters 29 exhibiting colors different from each other extend along the extension direction (Y-axis direction) of the source wiring line 26. In this manner, the plurality of types of color filters 29 exhibiting colors different from each other are arrayed in a vertical stripe pattern as a whole. The plurality of color filters 29 exhibiting colors different from each other are disposed such that boundaries thereof (color boundaries) overlap the source wiring line 26. The color filters 29 include three types that are a green color filter (first color filter) exhibiting green, a blue color filter (second color filter) exhibiting blue, and a red color filter (third color filter) exhibiting red. The green color filter, together with the overlapping pixel electrode 28, constitutes a green pixel (first pixel) exhibiting green. The blue color filter, together with the overlapping pixel electrode 28, constitutes a blue pixel (second pixel) exhibiting blue. The red color filter, together with the overlapping pixel electrode 28, constitutes a red pixel (third pixel) exhibiting red. In FIG. 6 and the like, the colors exhibited by the color filters 29 are denoted by characters of red (R), green (G), and blue (B).

The counter-side light blocking portion 20BM is made of a synthetic resin material or the like featuring excellent light-blocking properties, and is provided on the inner face of the glass substrate 20GS as illustrated in FIG. 7. The counter-side light blocking portion 20BM extends along the X-axis direction and is disposed overlapping the gate wiring line 25 included in the array substrate 21. A plurality of the counter-side light blocking portions 20BM are arranged side by side at intervals in the Y-axis direction, and are arranged in a horizontal stripe pattern in plan view. The overcoat film 200C is provided on the upper layer side of the counter-side light blocking portion 20BM, and is solidly arranged over substantially the entire region of the counter substrate 20. Thus, the counter substrate 20 can be flattened. The counter-side alignment film 20PI is provided on the upper layer side of the overcoat film 200C, and is arranged to face the liquid crystal layer 22. As in the alignment film 38 on the array substrate 21 side, the counter-side alignment film 20PI includes an upper face made of an organic material such as polyimide, for example, facing the liquid crystal layer 22, subjected to optical alignment treatment, and thus has a function of aligning liquid crystal molecules.

As illustrated in FIG. 7, the spacer 39 protrudes in the Z-axis direction (normal direction of a main surface of the counter substrate 20) from the counter substrate 20 toward the array substrate 21 side. Specifically, the spacer 39 is composed of a resin material, protrudes in the Z-axis direction from a surface of the overcoat film 200C in the display region AA of the counter substrate 20 toward the array substrate 21 side, and a protrusion tip end face thereof faces the array substrate 21. The spacer 39 has a slightly tapered cylindrical shape as a whole. The spacer 39 may include two types of spacers having different protrusion heights from the overcoat film 200C. FIG. 7 illustrates the spacer 39 having a large protrusion height. In the spacer 39 having the large protrusion height, a protrusion tip end face thereof is in contact with the inner face (alignment film 38) of the array substrate 21. On the other hand, in the spacer 39 having a small protrusion height, a clearance is provided between the protrusion tip end face and the inner face of the array substrate 21, and the protrusion tip end face comes into contact with the inner face of the array substrate 21 only when one of the pair of substrates 20 and 21 is bent inward due to the action of an external force. Such a spacer 39 can maintain an interval (a thickness of the liquid crystal layer 22, a cell gap) between the pair of substrates 20 and 21. As illustrated in FIG. 5, the spacer 39 is disposed overlapping the gate electrode 27A provided in a specific TFT 27 (for example, a TFT 27 connected to the pixel electrode 28 constituting the blue pixel having the lowest luminosity factor) among the plurality of TFTs 27 arranged along the X-axis direction.

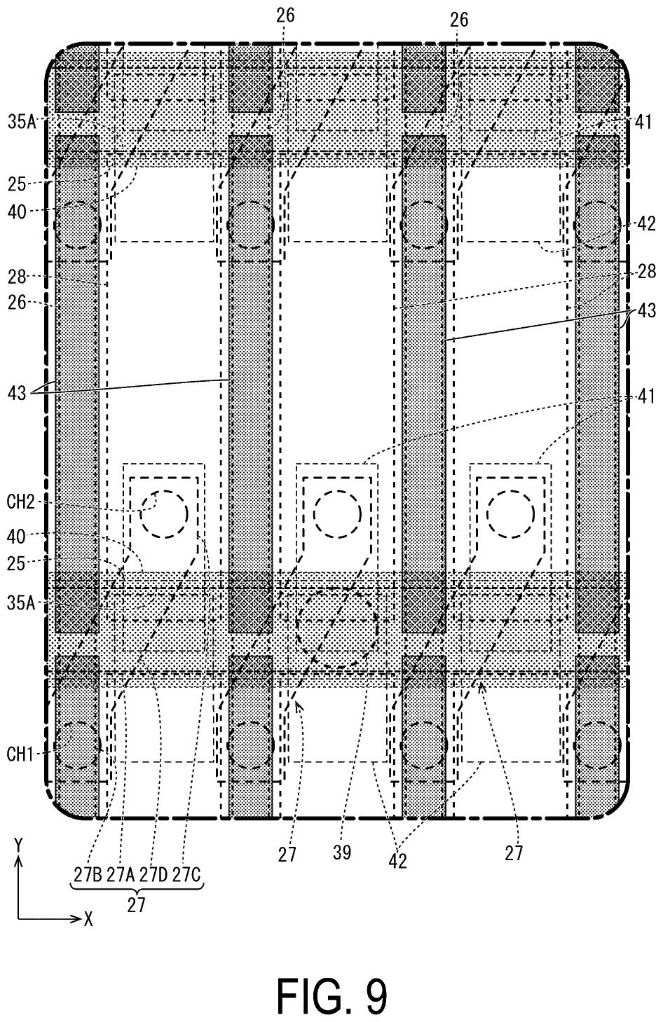

Next, a planar shape and the like of the first light blocking portion 40 including the first metal film and the second light blocking portion 43 including the fourth metal film will be described mainly with reference to FIG. 9. In FIG. 9, the configuration including the first metal film and the fourth metal film (the first light blocking portion 40 and the second light blocking portion 43) is illustrated with different shading. As illustrated in FIG. 9, the first light blocking portion 40 has a horizontally long belt shape extending along the X-axis direction, and most of the first light blocking portion 40 is disposed overlapping the gate wiring line 25 in plan view. A width dimension of the first light blocking portion 40 is slightly larger than a width dimension of the gate wiring line 25, and both end portions in the width direction (Y-axis direction) protrude from both side edges of the gate wiring line 25. Thus, it can be said that the first light blocking portion 40 covers the entire region of the semiconductor portion 27D from the back side, the semiconductor portion 27D being disposed overlapping the gate electrode 27A including part of the gate wiring line 25. As a result, the light traveling from the backlight device 12 to the semiconductor portion 27D can be effectively blocked by the first light blocking portion 40.

As illustrated in FIG. 9, the second light blocking portion 43 has a vertically long belt shape extending along the Y-axis direction, and most of the second light blocking portion 43 is disposed overlapping the source wiring line 26 in plan view. A width dimension of the second light blocking portion 43 is slightly larger than a width dimension of the source wiring line 26, and both end portions in the width direction (X-axis direction) protrude from both side edges of the source wiring line 26. A length dimension of the second light blocking portion 43 is larger than a dimension of the pixel electrode 28 in the Y-axis direction, and both end portions of the second light blocking portion 43 in a length direction (Y-axis direction) are disposed overlapping the two gate wiring lines 25, respectively, interposing the pixel electrode 28 in plan view. It can be said that the second light blocking portion 43 having such configuration partitions two pixel electrodes 28 adjacent to each other across the source wiring line 26 in the X-axis direction over the entire length in the Y-axis direction. The second light blocking portions 43 are arranged regularly at intervals in both the X-axis direction and the Y-axis direction. The number of the second light blocking portions 43 provided in the X-axis direction matches the number of the source wiring lines 26 provided. The number of the second light blocking portions 43 provided in the Y-axis direction matches the number of the pixel electrode 28 arranged in the Y-axis direction.

As illustrated in FIG. 6, the second light blocking portion 43 including the fifth metal film, is disposed on the upper layer side of the common electrode 30 including the fourth transparent electrode film, and is in direct contact with the common electrode 30. Thus, the second light blocking portion 43 has the same potential (common potential) as the common electrode 30. The second light blocking portion 43 can block light emitted from the backlight device 12 toward the liquid crystal panel 11 for example. The second light blocking portion 43 partitions the pixel electrodes 28 adjacent to each other in the X-axis direction and is disposed at a boundary between the color filters 29 that are adjacent to each other in the X-axis direction and exhibit colors different from each other. Thus, for example, even when the light transmitted through the pixel electrode 28 constituting the green pixel travels to the color filter 29 exhibiting red or the color filter 29 exhibiting blue, the light can be blocked by the second light blocking portion 43. Similarly, even when the light transmitted through the pixel electrode 28 constituting the blue pixel travels to the color filter 29 exhibiting red or the color filter 29 exhibiting green, the light can be blocked by the second light blocking portion 43. In addition, for example, even when the light transmitted through the pixel electrode 28 constituting the red pixel travels to the color filter 29 exhibiting green or the color filter 29 exhibiting blue, the light can be blocked by the second light blocking portion 43. As a result, since color mixing is less likely to occur due to the second light blocking portion 43, display independence of display of each pixel exhibiting each color is ensured. Particularly, since the second light blocking portion 43 includes the fourth metal film and is disposed on the upper layer side of the common electrode 30, that is disposed closer to the liquid crystal layer 22 next to the alignment film 38 in the array substrate 21. light that may cause color mixing can be blocked more. As a result, a higher color mixing prevention function is achieved.

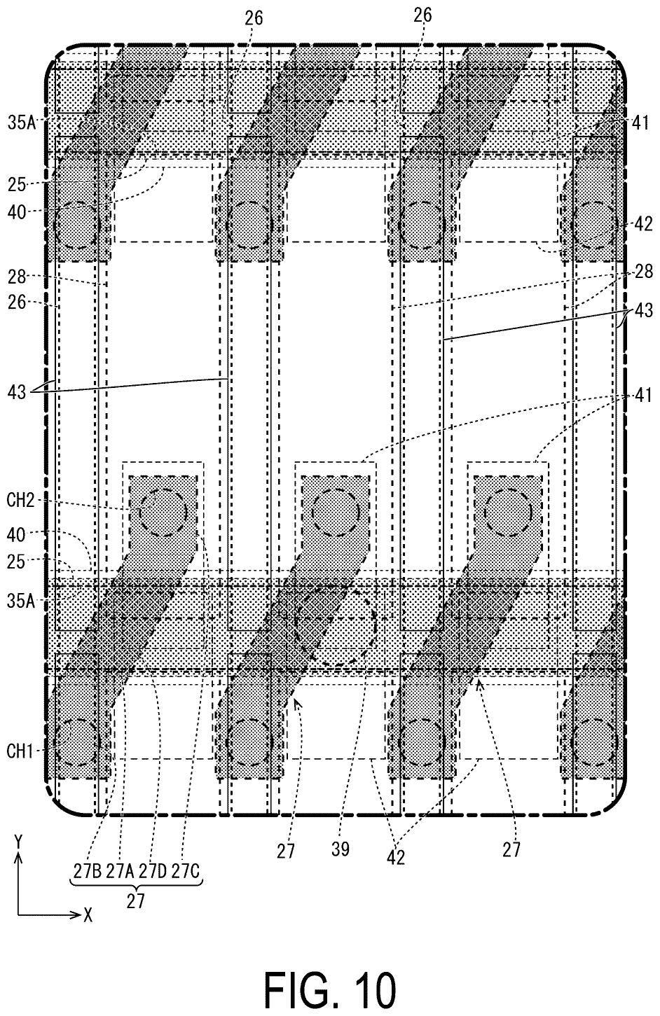

Next, the planar shapes and the like of the source electrode 27B, the drain electrode 27C, and the semiconductor portion 27D including the semiconductor film will be described mainly with reference to FIG. 10. In FIG. 10, the configurations including the second metal film and the semiconductor film (the gate wiring line 25, the gate electrode 27A, the source electrode 27B, the drain electrode 27C, and the semiconductor portion 27D) are illustrated with different shading. As illustrated in FIG. 10, the source electrode 27B, the drain electrode 27C, and the semiconductor portion 27D extend along a direction oblique to the Y-axis direction and disposed to cross the gate wiring line 25. The source electrode 27B is disposed adjacent to the semiconductor portion 27D overlapping the gate wiring line 25 (gate electrode 27A) on the side (lower side in FIG. 10) of the pixel electrode 28 to be connected in the Y-axis direction. One end portion (upper side in FIG. 10) of the source electrode 27B is continuous with the semiconductor portion 27D, while the other end portion (lower side in FIG. 10) of the source electrode 27B is disposed overlapping the source wiring line 26 in plan view. The drain electrode 27C is disposed adjacent to the semiconductor portion 27D overlapping the gate wiring line 25 on the opposite side (upper side in FIG. 10) of the pixel electrode 28 to be connected in the Y-axis direction. That is, the source electrode 27B and the drain electrode 27C are disposed to interpose the gate wiring line 25 and the semiconductor portion 27D therebetween in the Y-axis direction. One end portion (lower side in FIG. 10) of the drain electrode 27C is continuous with the semiconductor portion 27D, while the other end portion (upper side in FIG. 10) of the drain electrode 27C is disposed overlapping the first electrode 41 in plan view. The other end portion of the drain electrode 27C is disposed overlapping part of the pixel electrode 28 not to be connected, and is disposed substantially at the center of the pixel electrode 28 in the X-axis direction.

As illustrated in FIG. 8, the source electrode 27B is connected to the source wiring line 26 through a first contact hole CH1 provided in the gate insulating film 32 and the first interlayer insulating film 33 which are interposed between the source electrode 27B and the source wiring line 26 to be connected. The first contact hole CH1 is disposed at a position overlapping both the other end portion of the source electrode 27B and the source wiring line 26, and is provided to communicate with the gate insulating film 32 and the first interlayer insulating film 33.

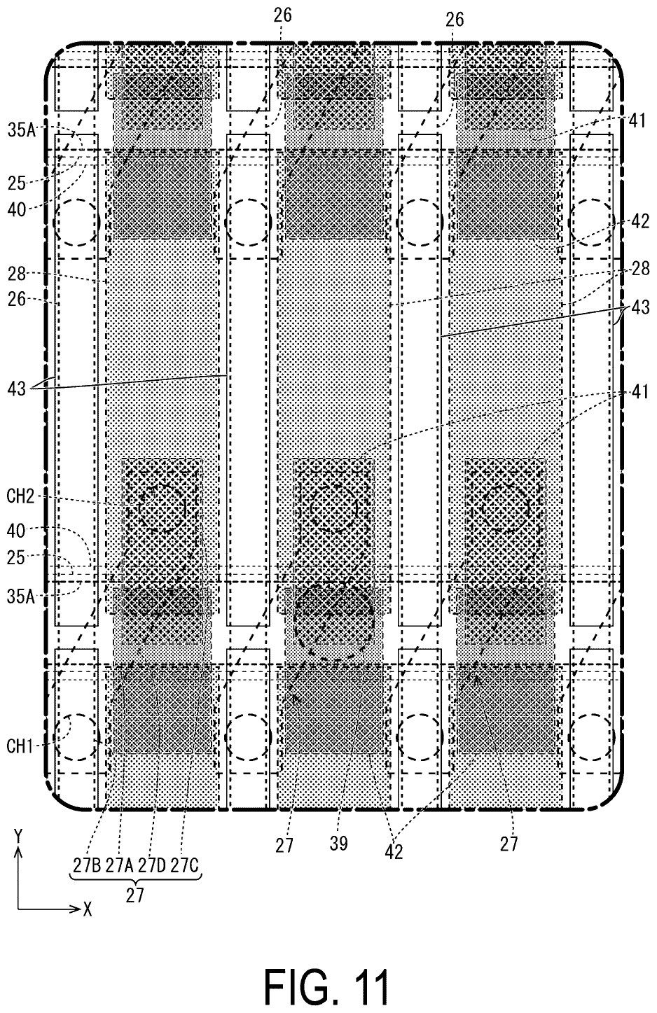

Next, the planar shapes and the like of the first electrode 41 including the first transparent electrode film, the second electrode 42 including the second transparent electrode film, and the pixel electrode 28 including the third transparent electrode film will be described mainly with reference to FIG. 11. In FIG. 11, the configuration including the first transparent electrode film, the second transparent electrode film, and the third transparent electrode film (the first electrode 41, the second electrode 42, and the pixel electrode 28) is illustrated with different shading. As illustrated in FIG. 11, each of the first electrode 41, the second electrode 42, and the pixel electrode 28 has a vertically long square shape extending along the Y-axis direction. The pixel electrode 28 is disposed at a position to interpose the gate wiring line 25 in the Y-axis direction with respect to the drain electrode 27C to be connected. The first electrode 41 connected to the drain electrode 27C and the second electrode 42 connected to the pixel electrode 28 are connected to each other at a position overlapping the gate wiring line 25. Specifically, one end portion (upper side in FIG. 11) of the first electrode 41 is disposed overlapping one end portion of the drain electrode 27C, and the other end portion (lower side in FIG. 11) of the first electrode 41 is disposed overlapping most of the gate electrode 27A and the semiconductor portion 27D. One end portion (upper side in FIG. 11) of the second electrode 42 is disposed overlapping the other end portion of the first electrode 41, and the other end portion (lower side in FIG. 11) of the second electrode 42 is disposed overlapping part of the pixel electrode 28. A plurality of the first electrodes 41 and a plurality of the second electrodes 42 are arranged side by side at intervals in the X-axis direction, and an arrangement interval thereof is equal to an arrangement interval of the plurality of pixel electrodes 28 in the X-axis direction. The plurality of first electrodes 41 and the plurality of second electrodes 42 are arranged alternately and repeatedly with a plurality of the second light blocking portions 43 in the X-axis direction. That is, the second light blocking portion 43 is interposed between two first electrodes 41 and two second electrodes 42 that are adjacent to each other with an interval therebetween in the X-axis direction. The first electrode 41 and the second electrode 42 are interposed between two second light blocking portions 43 adjacent to each other with an interval therebetween in the X-axis direction.

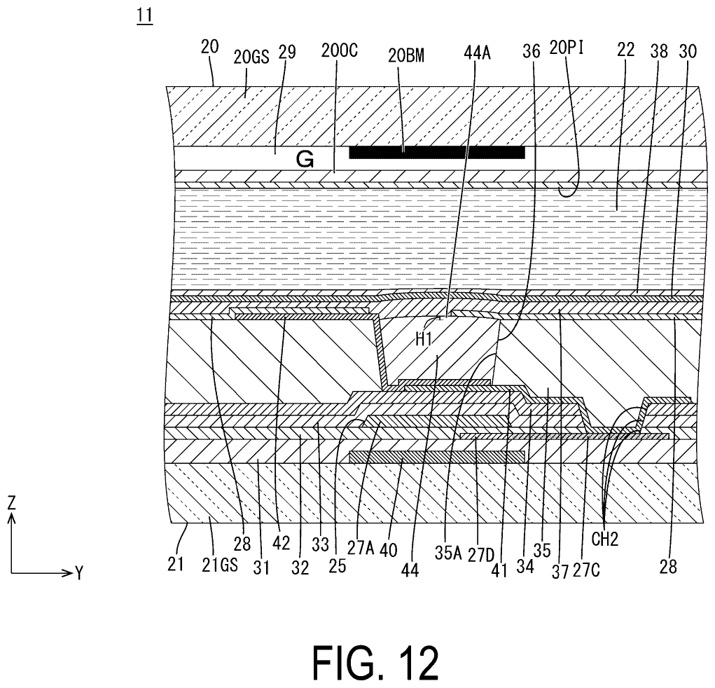

As illustrated in FIG. 12, the first electrode 41 is connected to the drain electrode 27C through a second contact hole CH2 provided in the gate insulating film 32, the first interlayer insulating film 33, and the second interlayer insulating film 34 which are interposed between the first electrode 41 and the drain electrode 27C to be connected. The second contact hole CH2 is disposed at a position overlapping both the one end portion of the first electrode 41 and the other end portion of the drain electrode 27C, and is provided to communicate with the gate insulating film 32, the first interlayer insulating film 33, and the second interlayer insulating film 34.

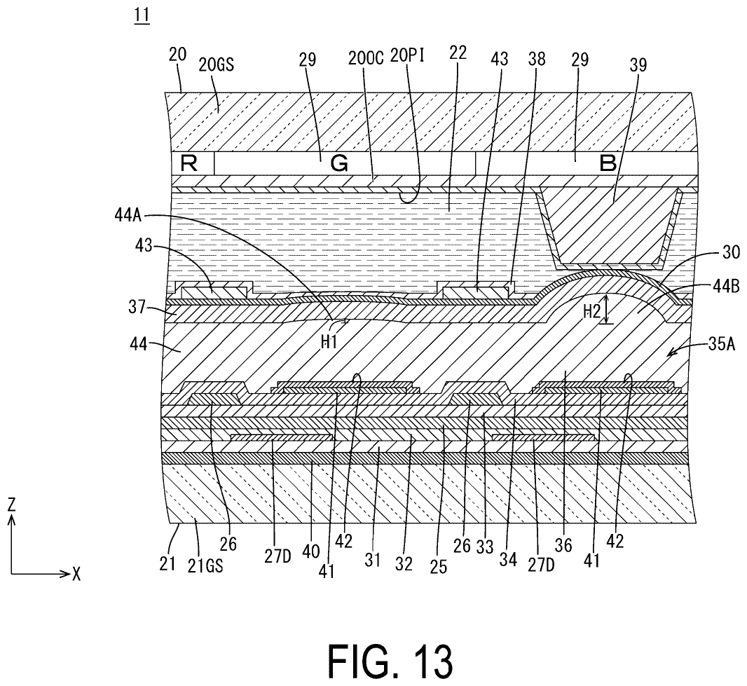

As illustrated in FIG. 12, the second electrode 42 is connected to the first electrode 41 through an opening 35A provided in the first flattening film 35 interposed between the second electrode 42 and the first electrode 41 to be connected. The opening 35A is disposed at a position overlapping both the one end portion of the second electrode 42 and the other end portion of the first electrode 41, and is provided to penetrate the first flattening film 35 along the Z-axis direction. The opening 35A is also disposed overlapping the gate electrode 27A, the semiconductor portion 27D, and the first light blocking portion 40 in plan view. As illustrated in FIG. 13, the opening 35A is also provided in a portion of the first flattening film 35 other than a portion overlapping both the first electrode 41 and the second electrode 42. That is, the opening 35A is provided to extend along the X-axis direction to cross the plurality of first electrodes 41 and the plurality of second electrodes 42 arranged at intervals in the X-axis direction. The opening 35A overlaps most of the gate wiring line 25 in plan view, and has a length corresponding to substantially the entire length of the display region AA in the X-axis direction. The opening 35A has a width dimension slightly smaller than a width dimension of the gate wiring line 25, and both side edges of the gate wiring line 25 do not overlap the opening 35A. The opening 35A is also disposed overlapping all of the gate electrodes 27A, the semiconductor portions 27D, the source wiring lines 26, the first light blocking portions 40, and the second light blocking portions 43 arranged along the X-axis direction in plan view in addition to all of the first electrodes 41 and the second electrodes 42 arranged along the X-axis direction. One end portion (the right side in FIG. 12 and the upper side in FIG. 11) of the pixel electrode 28 is connected to the other end portion of the second electrode 42 in a direct contact manner from the upper layer side.

As illustrated in FIG. 12, in the array substrate 21 according to the present embodiment, an insulating portion 44 is provided in the opening 35A of the first flattening film 35. The insulating portion 44 includes the second flattening film 36 located on the upper layer side of the second transparent electrode film constituting the second electrode 42, and is provided to fill the opening 35A. Thus, the insulating portion 44 covers the first electrode 41 and the second electrode 42 in the opening 35A. The pixel electrode 28, the third interlayer insulating film 37, and the common electrode 30 located on the upper layer side than the second flattening film 36 are flattened by the insulating portion 44. The second flattening film 36 is not formed outside the opening 35A in the display region AA. As a result, since the second flattening film 36 is not interposed between an overlapping part of the second electrode 42 including the second transparent electrode film and the pixel electrode 28 including the third transparent electrode film, the second electrode 42 and the pixel electrode 28 are connected to each other through direct contact.

Specifically, as illustrated in FIG. 13, the insulating portion 44 is provided to fill the opening 35A extending along the X-axis direction over the entire width and the entire length. That is, the insulating portion 44 extends along the X-axis direction, crosses the plurality of first electrodes 41 and the plurality of second electrodes 42 arranged at intervals in the X-axis direction, and is disposed overlapping part of the first electrode 41 and part of the second electrode 42. The insulating portion 44 overlaps most of each of the gate wiring line 25 and the first light blocking portion 40 in plan view, and has a length corresponding to substantially the entire length of the display region AA in the X-axis direction. The insulating portion 44 has substantially the same width dimension and length dimension as those of the opening 35A. The insulating portion 44 has the width dimension slightly smaller than a width dimension of the gate wiring line 25, and both side edges of the gate wiring line 25 do not overlap the insulating portion 44. The insulating portion 44 is also disposed overlapping all of the gate electrodes 27A and the semiconductor portions 27D arranged along the X-axis direction in plan view in addition to all of the first electrodes 41 and the second electrodes 42 arranged along the X-axis direction. The insulating portion 44 crosses the plurality of source wiring lines 26 and the plurality of second light blocking portions 43 arranged at intervals in the X-axis direction, and is disposed overlapping part of the source wiring line 26 and part of the second light blocking portion 43. The insulating portion 44 is also disposed overlapping the other end portion (the left side in FIG. 12 and the lower side in FIG. 11) of the pixel electrode 28 in plan view. As described above, since the insulating portion 44 extends along the X-axis direction together with the opening 35A and is provided to cross the plurality of first electrodes 41 and the plurality of second electrodes 42, the following effect is obtained as compared with a case where a plurality of the openings and a plurality of the insulating portions are provided at intervals in the X-axis direction. That is, even when a photomask used for patterning the opening 35A and the insulating portion 44 has a positional offset in the X-axis direction during manufacturing, the opening 35A and the insulating portion 44 are prevented from being provided in a state of having the positional offset in the X-axis direction. In particular, this is suitable for a case where an arrangement interval of the openings 35A and the insulating portions 44 in the X-axis direction is narrowed along with higher definition.

As illustrated in FIGS. 12 and 13, the insulating portion 44 includes a high level portion 44A higher than an opening edge of the opening 35A of the first flattening film 35. The high level portion 44A is disposed at a position overlapping the gate electrode 27A and the semiconductor portion 27D of the TFT 27. The high level portion 44A is provided in a substantially circular range that is substantially concentric with the center of the overlapping part of the first electrode 41 and the second electrode 42 in plan view in the insulating portion 44. The diameter of the high level portion 44A is about the width dimension of the insulating portion 44. Thus, the high level portion 44A is partially provided in the insulating portion 44 extending along the X-axis direction and having a belt shape, and has an island shape (dot shape) in plan view. A plurality of the high level portions 44A are arranged side by side at intervals in the X-axis direction, and each of the high level portions 44A is disposed to be interposed between the two second light blocking portions 43 in the X-axis direction. Specifically, the high level portion 44A is disposed overlapping the gate electrode 27A included in the TFT 27 (for example, the TFT 27 connected to the pixel electrode 28 constituting the green pixel and the red pixel) that does not overlap the spacer 39 among the plurality of TFTs 27 arranged along the X-axis direction. The other end portion of the pixel electrode 28 is disposed to ride on the high level portion 44A.

According to the high level portion 44A having such a configuration, in each of the pixel electrode 28, the third interlayer insulating film 37, the common electrode 30, and the alignment film 38 located on the upper layer side than the first flattening film 35, a portion overlapping the high level portion 44A in plan view is higher than the other portions. Thus, in the step of forming the alignment film 38 in the manufacturing process of the array substrate 21, when the material of the alignment film 38 is applied to the upper layer side of the common electrode 30 and the second light blocking portion 43, the material of the alignment film 38 is likely to flow from a position on the high level portion 44A to a position other than a position on the high level portion 44A, and the material of the alignment film 38 is less likely to accumulate on the insulating portion 44. As a result, since a situation is less likely to occur in which the material of the alignment film 38 is insufficient at the position other than a position on the insulating portion 44, film thickness unevenness of the alignment film 38 is less likely to occur at the position other than the position on the insulating portion 44. In the present embodiment, since the high level portion 44A is disposed to be interposed between the two second light blocking portions 43 in the X-axis direction, when the alignment film 38 is formed, the material of the alignment film 38 can be caused to flow from the high level portion 44A side toward the two second light blocking portions 43 interposing the high level portion 44A in the X-axis direction. As a result, since a large amount of the material is supplied to the portions of the alignment film 38 overlapping the two second light blocking portions 43 interposing the high level portion 44A, the coverage of the alignment film 38 with respect to each second light blocking portion 43 is improved. Accordingly, a situation may be less likely to occur in which the portions of the alignment film 38 located on the second light blocking portions 43 are locally thinned. As described above, since film thickness unevenness of the alignment film 38 is suppressed in the array substrate 21, an alignment defect is less likely to occur in the liquid crystal molecules contained in the liquid crystal layer 22. As a result, the display quality is improved.

As illustrated in FIGS. 12 and 13, the high level portion 44A is configured to be gradually higher from the outer peripheral end side toward the center side of the insulating portion 44. The high level portion 44A is configured to be highest at a center position and lowest at an outer peripheral end position in plan view. With this configuration, when the alignment film 38 is formed, the material of the alignment film 38 is likely to flow radially from the center side toward the outer peripheral end side of the insulating portion 44. As a result, the material of the alignment film 38 can be smoothly supplied to the position other than the position on the insulating portion 44, and thus the film thickness unevenness of the alignment film 38 is further less likely to occur at the position other than the position on the insulating portion 44.

As illustrated in FIGS. 12 and 13, in the high level portion 44A, a height H1 from the opening edge of the opening 35A of the first flattening film 35 is smaller than the film thickness of the alignment film 38. The height H1 is a dimension along the Z-axis direction from the opening edge of the opening 35A of the first flattening film 35 to the highest position (the center position in plan view) of the high level portion 44A. Specifically, the height H1 of the high level portion 44A is in a range, for example, from about 0.1 μm to about 0.5 μm. As described above, the height of the high level portion 44A is smaller than the film thickness of the alignment film 38, and thus when the alignment film 38 is formed, the material of the alignment film 38 is likely to be present on the insulating portion 44. Specifically, the alignment film 38 has slightly smaller film thickness on the high level portion 44A as compared with the film thickness at the position other than the portion on the high level portion 44A, but is continuously formed. As a result, a situation is less likely to occur in which the alignment film 38 is disconnected on the insulating portion 44.

As illustrated in FIGS. 7 and 13, a bump 44B is provided at a position of the insulating portion 44 overlapping the spacer 39 of the counter substrate 20. The bump 44B is provided to be higher than the opening edge of the opening 35A of the first flattening film 35. The bump 44B is disposed at a position overlapping the gate electrode 27A and the semiconductor portion 27D of the TFT 27. The bump 44B is provided in a substantially circular range that is substantially concentric with the center of the overlapping part of the first electrode 41 and the second electrode 42 in plan view in the insulating portion 44. The diameter of the bump 44B is about the width dimension of the insulating portion 44. Thus, the bump 44B is partially provided in the insulating portion 44 extending along the X-axis direction and having a belt shape, and has an island shape in plan view. A plurality of the bumps 44B are arranged side by side at intervals in the X-axis direction, and each of the bumps 44B is disposed to be interposed between the two second light blocking portions 43 in the X-axis direction. Specifically, the bump 44B is disposed overlapping the gate electrode 27A included in the TFT 27 (for example, the TFT 27 connected to the pixel electrode 28 constituting the blue pixel having the lowest luminosity factor) that overlaps the spacer 39 among the plurality of TFTs 27 arranged along the X-axis direction. According to such a configuration, the spacer 39 can be in contact with a portion of the inner face of the array substrate 21 overlapping the bump 44B included in the insulating portion 44. This ensures that the spacing (cell gap) between the array substrate 21 and the counter substrate 20 facing each other is well maintained. In manufacturing the array substrate 21, the insulating portion 44 including the bump 44B in addition to the high level portion 44A can be provided by patterning the second flattening film 36, and thus the number of steps can be reduced as compared with a case where the bump is provided separately from the insulating portion 44.

As illustrated in FIG. 13, in the bump 44B, a height H2 from the opening edge of the opening 35A of the first flattening film 35 is larger than the height H1 of the high level portion 44A. That is, the high level portion 44A is formed to be lower than the bump 44B. Specifically, the height H2 of the bump 44B is, for example, about 1 μm. As compared with a case where the height of the high level portion is equal to or higher than the height of the bump 44B, a step generated between the insulating portion 44 and the opening edge of the opening 35A of the first flattening film 35 is reduced. As a result, a pattern defect is less likely to occur in the pixel electrode 28 disposed to ride on the high level portion 44A.

As illustrated in FIG. 13, the first light blocking portion 40 extends along the X-axis direction and is disposed overlapping the insulating portion 44, and thus even when an alignment defect occurs in a portion of the alignment film 38 overlapping the insulating portion 44, light can be blocked by the first light blocking portion 40. As a result, inadvertent light leakage can be suppressed.

The liquid crystal display device 10 according to the present embodiment has the above-described structure, and a manufacturing method thereof will be subsequently described. The liquid crystal display device 10 is manufactured by assembling the liquid crystal panel 11 and the backlight device 12 which are separately manufactured. The manufacturing method of the liquid crystal panel 11 includes a counter substrate manufacturing step (CF substrate manufacturing step) of manufacturing the counter substrate 20, an array substrate manufacturing step (substrate manufacturing step) of manufacturing the array substrate 21, and a bonding step of bonding the manufactured counter substrate 20 and the array substrate 21 together. Hereinafter, the array substrate manufacturing step of the above steps will be described.

The array substrate manufacturing step includes at least a first step of forming and patterning the first metal film, a second step of forming the base coat film 31, a third step of forming and patterning the semiconductor film, a fourth step of forming the gate insulating film 32, a fifth step of forming and patterning the second metal film, a sixth step of selectively reducing resistance of the semiconductor film by using the patterned second metal film as a mask, a seventh step of forming and patterning the first interlayer insulating film 33, an eighth step of forming and patterning the third metal film, a ninth step of forming and patterning the second interlayer insulating film 34, a tenth step of forming and patterning the first transparent electrode film, an eleventh step of forming and patterning the first flattening film 35, a twelfth step of forming and patterning the second transparent electrode film, a thirteenth step of forming and patterning the second flattening film 36, a fourteenth step of forming and patterning the third transparent electrode film, a fifteenth step of forming the third interlayer insulating film 37, a sixteenth step of forming and patterning the fourth transparent electrode film, a seventeenth step of forming and patterning the light blocking film, and an eighteenth step of forming the alignment film 38.

The first light blocking portion 40 is formed through the first step among the steps. The semiconductor portion 27D is formed through the third step. The gate wiring line 25 and the gate electrode 27A are formed through the fifth step. The source electrode 27B and the drain electrode 27C are formed through the sixth step. The first contact hole CH1 is formed through the seventh step. The source wiring line 26 is formed through the eighth step. The second contact hole CH2 is formed through the ninth step. The first electrode 41 is formed through the tenth step. The opening 35A is formed through the eleventh step. The second electrode 42 is formed through the twelfth step. The insulating portion 44 (including the high level portion 44A and the bump 44B) is formed through the thirteenth step. The pixel electrode 28 is formed through the fourteenth step. The common electrode 30 is formed through the sixteenth step. The second light blocking portion 43 is formed through the seventeenth step.

The term “patterning” described above means process of a film based on a general photolithography method. Specifically, the process, that is, the patterning of a film to be processed is performed by performing the film formation of the photoresist film on the film to be processed, exposing the photoresist film with an exposure device through a photomask having a predetermined opening pattern, and then developing the photoresist film, and performing etching through the developed photoresist film.

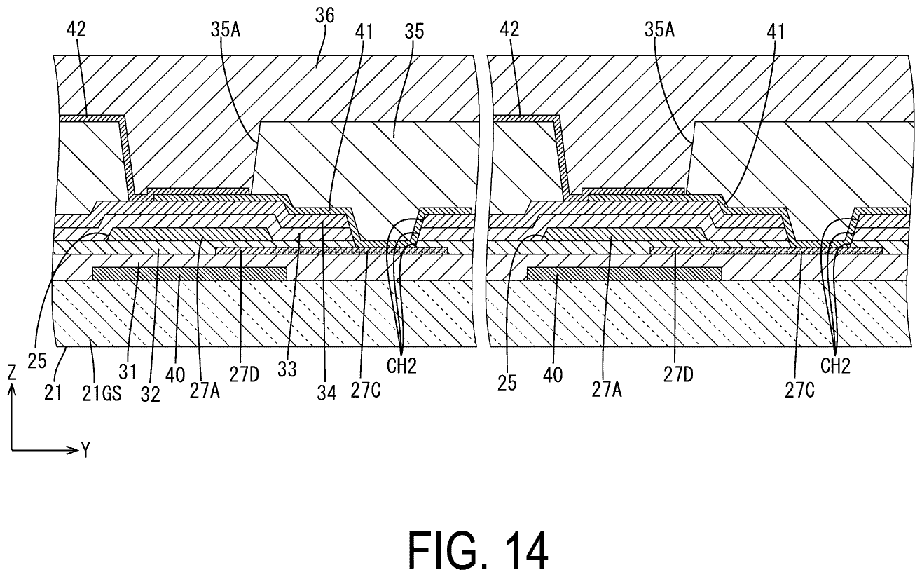

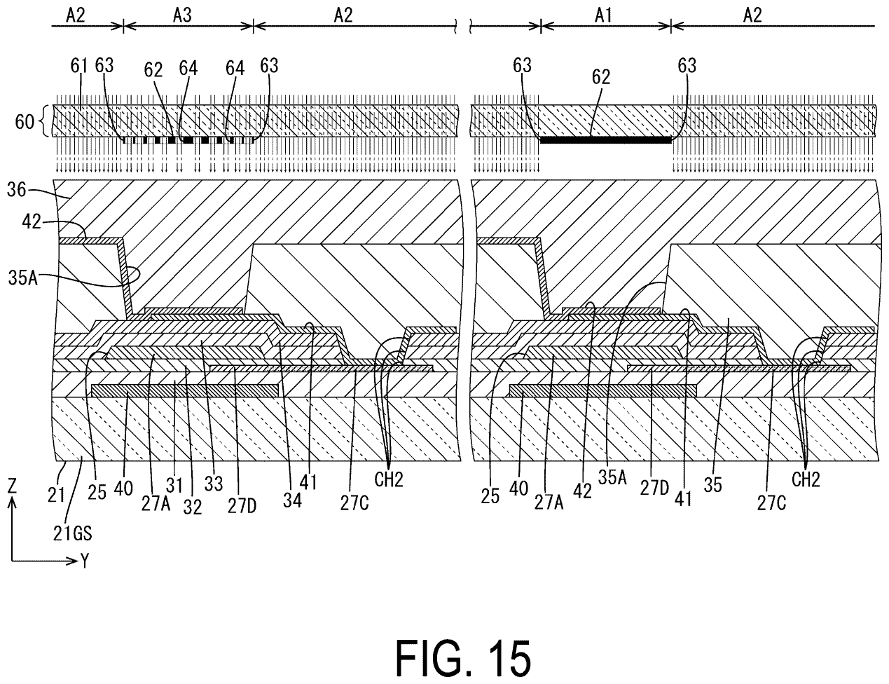

The thirteenth step among the steps will be described in detail. As illustrated in FIG. 14, in the thirteenth step, the second flattening film 36 is formed on the second transparent electrode film patterned through the twelfth step (film forming step). Thereafter, the second flattening film 36 is exposed using an exposure device and a photomask 60 (exposure step). The second flattening film 36 is made of an organic material having positive photosensitivity. Here, the photomask 60 will be described. As illustrated in FIG. 15, the photomask 60 includes a transparent base material 61A having sufficiently high light-transmittance and a light blocking film 62 formed on a main surface of the base material 61. The light blocking film 62 blocks exposure light from the light source of the exposure device, and has a partial opening 63. Note that, in FIG. 15, exposure light emitted to the second flattening film 36 is represented by a downward arrow.

The photomask 60 used in the exposure step included in the thirteenth step is a so-called graytone mask. Specifically, as illustrated in FIG. 15, a plurality of slits 64 each having a size equal to or smaller than a resolution of the exposure device are formed in part of the light blocking film 62 constituting the photomask 60. The transmittance of the exposure light in a portion of the light blocking film 62 where the slits 64 are formed is higher than the transmittance (substantially 0%) of exposure light in the light blocking film 62, and is, for example, from about 10% to about 70%. The transmittance of the exposure light at the portion of the light blocking film 62 where the slits 64 are formed is changed in accordance with a distribution density of the slits 64, and the transmittance of the exposure light tends to increase as the distribution density of the slits 64 increases. The opening 63 is larger than the resolution of the exposure device, and the transmittance of exposure light through the opening 63 is substantially 100%.

As illustrated in FIG. 15, the photomask 60 includes a light blocking region A1 in which light is blocked in the formation range of the light blocking film 62, a light transmitting region A2 through which light is transmitted in the formation range of the opening 63, and a light semi-transmitting region A3 in which light is semi-transmitted in the formation range of the slit 64. The transmittance of the exposure light in the light semi-transmitting region A3 is higher than the transmittance in the light blocking region A1 and lower than the transmittance in the light transmitting region A2. In the present embodiment, in the photomask 60, the light blocking region A1 overlaps a formation scheduled position of the bump 44B in plan view, the light semi-transmitting region A3 overlaps a formation scheduled position of a portion of the insulating portion 44 excluding the bump 44B in plan view, and the light transmitting region A2 overlaps a formation scheduled position of a configuration other than the insulating portion 44 in plan view. Here, the light semi-transmitting region A3 includes a first light semi-transmitting region overlapping a formation scheduled position of the high level portion 44A of the insulating portion 44 in plan view, and a second light semi-transmitting region overlapping a formation scheduled position of a portion of the insulating portion 44 excluding the high level portion 44A and the bump 44B in plan view. FIG. 15 illustrates the first light semi-transmitting region among these regions. The distribution density of the slits 64 in the first light semi-transmitting region is lower than the distribution density of the slits 64 in the second light semi-transmitting region, and the transmittance of the exposure light in the first light semi-transmitting region is lower than the transmittance of the exposure light in the second light semi-transmitting region. The first light semi-transmitting region is configured such that the distribution density of the slits 64 is gradually lower from the center toward the outer peripheral end. In other words, the first light semi-transmitting region is configured such that a distribution density of the light blocking film 62 is gradually higher from the center toward the outer peripheral end. As a result, a transmitted light amount in the first light semi-transmitting region changes to gradually increase from the center toward the outer peripheral end. In the second light semi-transmitting region, the distribution density of the slits 64 is substantially constant over the entire region. As a result, a transmitted light amount in the second light semi-transmitting region is substantially constant over the entire region.

As illustrated in FIG. 15, in the exposure step included in the thirteenth step, when the exposure light emitted from the light source of the exposure device is emitted to the second flattening film 36 via the photomask 60 having the above-described configuration, the second flattening film 36 is selectively exposed to the light. Specifically, in the second flattening film 36, a portion overlapping the light transmitting region A2 of the photomask 60 has the largest exposure amount, a portion overlapping the light semi-transmitting region A3 of the photomask 60 has the second largest exposure amount, and a portion overlapping the light blocking region A1 of the photomask 60 is hardly exposed. In a portion of the second flattening film 36 overlapping the first light semi-transmitting region of the light semi-transmitting region A3, the exposure amount changes to gradually increase from the center toward the outer peripheral end. In a portion of the second flattening film 36 overlapping the second light semi-transmitting region of the light semi-transmitting region A3, the exposure amount is substantially constant over the entire region.

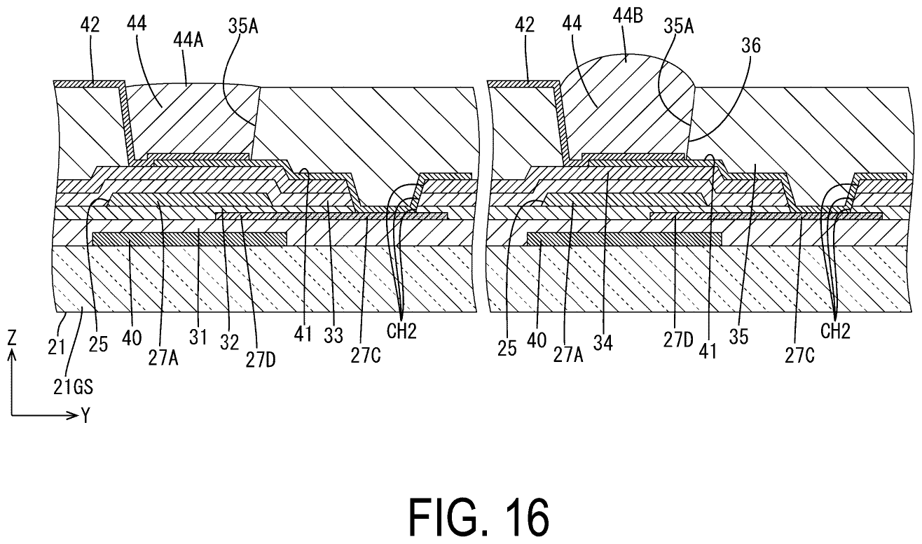

In the thirteenth step, the second flattening film 36 is developed after the exposure step (development step). Then, as illustrated in FIG. 16, the exposed portion of the second flattening film 36 is selectively removed in accordance with the exposure amount. The insulating portion 44 is provided to fill the opening 35A with the second flattening film 36 through the developing process. The insulating portion 44 provided through the thirteenth step includes the high level portion 44A configured to be gradually higher from the outer peripheral end side toward the center side, and the bump 44B higher than the high level portion 44A.

As described above, the array substrate 21 of the present embodiment includes the first electrode 41, the first flattening film (first insulating film) 35 disposed on the upper layer side of the first electrode 41 and provided with the opening 35A at the position overlapping at least the first electrode 41, the second electrode 42 disposed on the upper layer side of the first flattening film 35, overlapping the first electrode 41 at least in the opening 35A, and connected to the first electrode 41, the second flattening film (second insulating film) 36 disposed on the upper layer side of the second electrode 42, and the alignment film 38 disposed on the upper layer side than the second flattening film 36. The second flattening film 36 includes the insulating portion 44 disposed in the opening 35A, and the insulating portion 44 includes the high level portion 44A higher than the opening edge of the opening 35A of the first flattening film 35.

The second electrode 42 is connected to the first electrode 41 through the opening 35A of the first flattening film 35. The insulating portion 44 of the second flattening film 36 provided in the opening 35A of the first flattening film 35 includes the high level portion 35A higher than the opening edge of the opening 44A of the first flattening film 35, and thus when the alignment film 38 is formed, the material of the alignment film 38 is less likely to accumulate on the insulating portion 44 as compared with the related art. As a result, since the situation is less likely to occur in which the material of the alignment film 38 is insufficient at the position other than the position on the insulating portion 44, the film thickness unevenness of the alignment film 38 is less likely to occur at the position other than the position on the insulating portion 44.

The plurality of first electrodes 41 and the plurality of second electrodes 42 are arranged side by side at intervals in the first direction, and each of the opening 35A and the insulating portion 44 extends along the first direction and is disposed to cross the plurality of first electrodes 41 and the plurality of second electrodes 42. As described above, since each of the opening 35A and the insulating portion 44 extends along the first direction and is provided to cross the plurality of first electrodes 41 and the plurality of second electrodes 42, the following effect is obtained as compared with a case where the plurality of openings and the plurality of insulating portions are provided at intervals in the first direction. That is, even when a photomask used for patterning the opening 35A and the insulating portion 44 has a positional offset in the first direction during manufacturing, the opening 35A and the insulating portion 44 are prevented from being provided in a state of having the positional offset in the first direction. In particular, this is suitable for a case where an arrangement interval of the openings 35A and the insulating portions 44 in the first direction is narrowed along with higher definition.

The first light blocking portion 40 made of a light blocking material is provided on the lower layer side of the first electrode 41. The first light blocking portion 40 extends along the first direction and is disposed overlapping the insulating portion 44. As described above, since the first light blocking portion 40 extending along the first direction is disposed overlapping the insulating portion 44 extending along the first direction, even when the alignment defect occurs in the portion of the alignment film 38 overlapping the insulating portion 44, light can be blocked by the first light blocking portion 40, and thus inadvertent light leakage can be suppressed.

The second light blocking portion 43 disposed on the lower layer side of the alignment film 38 and made of the light blocking material is included, the plurality of second light blocking portions 43 are arranged side by side at intervals so as to interpose the first electrode 41 and the second electrode 42 in the first direction, and the high level portion 44A is disposed to be interposed between the two of the second light blocking portions 43 in the first direction. With this configuration, the light transmitted through the first electrode 41 and the second electrode 42 interposed between the two second light blocking portions 43 can be prevented from leaking to the side of the first electrode 41 and the second electrode 42 adjacent to each other with the second light blocking portion 43 interposed therebetween in the first direction. When the alignment film 38 is formed, the material of the alignment film 38 can be caused to flow from the high level portion 44A side toward the two second light blocking portions 43 interposing the high level portion 44A in the first direction. As a result, the situation can be less likely to occur in which the portions of the alignment film 38 overlapping the two second light blocking portions 43 interposing the high level portion 44A are locally thinned.

In the high level portion 44A, the height H1 from the opening edge of the opening 35A of the first flattening film 35 is smaller than the film thickness of the alignment film 38. As described above, the height H1 of the high level portion 44A is smaller than the film thickness of the alignment film 38, and thus when the alignment film 38 is formed, the material of the alignment film 38 is likely to be present on the insulating portion 44. As a result, a situation is less likely to occur in which the alignment film 38 is disconnected on the insulating portion 44.

The high level portion 44A is configured to be gradually higher from the outer peripheral end side toward the center side of the insulating portion 44. With this configuration, when the alignment film 38 is formed, the material of the alignment film 38 is likely to flow from the center side toward the outer peripheral end side of the insulating portion 44. As a result, the material of the alignment film 38 can be smoothly supplied to the position other than the position on the insulating portion 44, and thus the film thickness unevenness of the alignment film 38 is further less likely to occur at the position other than the position on the insulating portion 44.

The liquid crystal display device 10 according to the present embodiment includes the array substrate 21 described above, the counter substrate 20 arranged to face the array substrate 21, and the liquid crystal layer 22 disposed between the array substrate 21 and the counter substrate 20. According to such a liquid crystal display device 10, since the film thickness unevenness of the alignment film 38 is suppressed in the array substrate 21, the alignment defect is less likely to occur in the liquid crystal molecules contained in the liquid crystal layer 22. As a result, the display quality is improved.

The counter substrate 20 is provided with the spacer 39 protruding toward the array substrate 21, the plurality of first electrodes 41 and the plurality of second electrodes 42 are arranged side by side at intervals in the first direction, each of the opening 35A and the insulating portion 44 extends in the first direction and is disposed to cross the plurality of first electrodes 41 and the plurality of second electrodes 42, and the insulating portion 44 includes the bump 44B higher than the opening edge of the opening 35A of the first flattening film 35 and disposed overlapping the spacer 39. The spacer 39 provided on the counter substrate 20 and protruding toward the array substrate 21 can be in contact with a portion of the inner face of the array substrate 21 overlapping the bump 44B included in the insulating portion 44. This ensures that the spacing (cell gap) between the array substrate 21 and the counter substrate 20 facing each other is well maintained. In manufacturing the array substrate 21, the insulating portion 44 including the bump 44B in addition to the high level portion 44A can be provided by patterning the second flattening film 36, and thus the number of steps can be reduced as compared with a case where the bump is provided separately from the insulating portion 44.

The high level portion 44A is lower than the bump 44B. As compared with a case where the height of the high level portion is equal to or higher than the height of the bump 44B, the step generated between the insulating portion 44 and the opening edge of the opening 35A of the first flattening film 35 is reduced. As a result, for example, when an electrode or the like is provided on the insulating portion 44, a pattern defect is less likely to occur in the electrode or the like.

### Second Embodiment

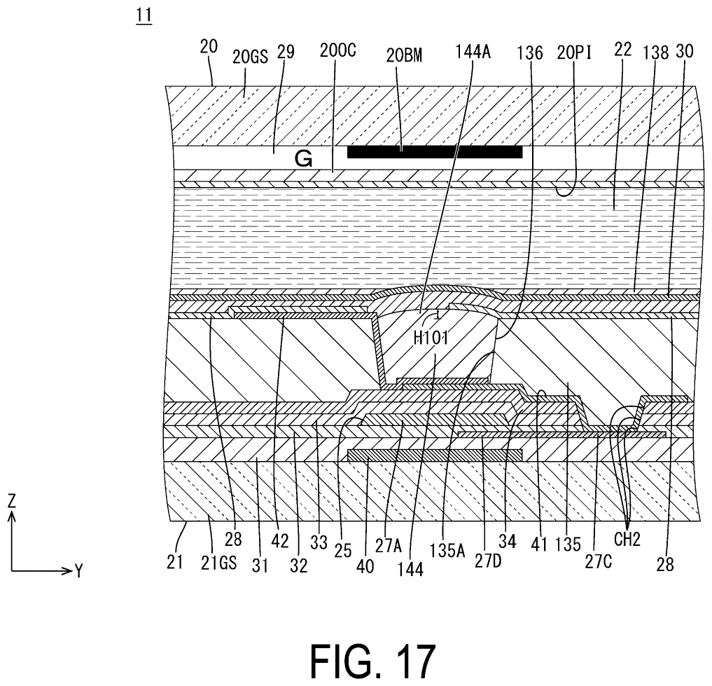

A second embodiment will be described with reference to FIGS. 17 to 19. In this second embodiment, an alternative configuration with an alignment film 138 and a high level portion 144A will be described. Further, repetitive descriptions of structures, actions, and effects similar to those of the first embodiment described above will be omitted.

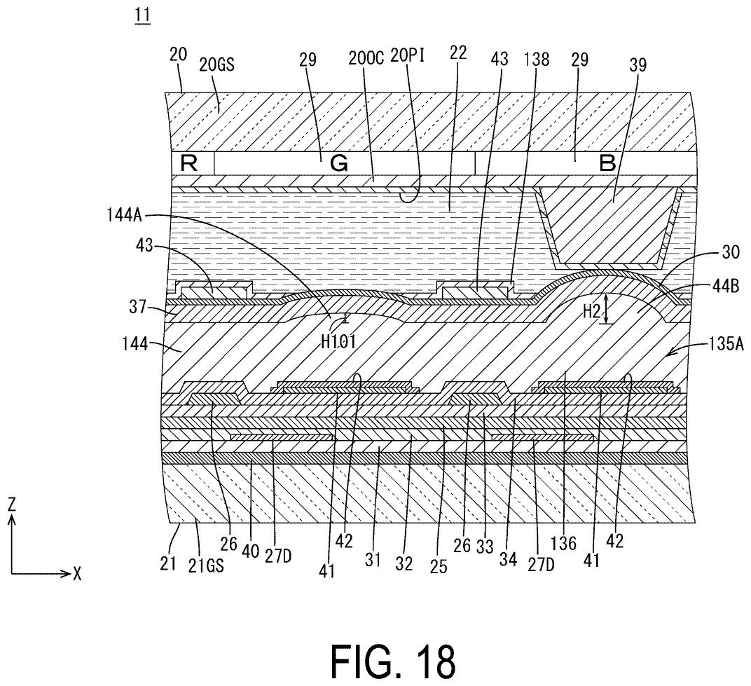

As illustrated in FIGS. 17 and 18, in the high level portion 144A according to the present embodiment, a height H101 from an opening edge of an opening 135A of the first flattening film 135 is larger than the height H1 (see FIG. 12) in the first embodiment and is larger than the film thickness of the alignment film 138. The height H101 of the high level portion 144A is in a range, for example, from about 0.1 μm to about 0.5 μm. As described above, the height H101 of the high level portion 144A is larger than the film thickness of the alignment film 138, and thus when the alignment film 138 is formed, the material of the alignment film 138 is less likely to be present on the insulating portion 144. In the present embodiment, the alignment film 138 is substantially not formed at a position overlapping the high level portion 144A in plan view. As a result, a larger amount of the material of the alignment film 138 can be supplied to the position other than a position on the insulating portion 144, and thus the film thickness unevenness of the alignment film 138 is further less likely to occur at the position other than the position on the insulating portion 144.

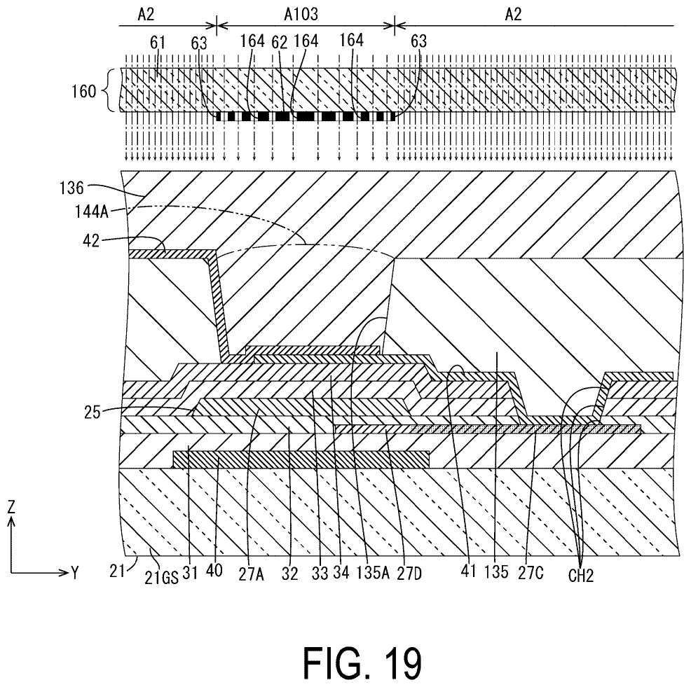

Next, a configuration of a photomask 160 used in the exposure step included in the thirteenth step of the array substrate manufacturing step will be described. As illustrated in FIG. 19, in the first light semi-transmitting region of a light semi-transmitting region A103 of the photomask 160, a distribution density of slits 164 is lower than the distribution density (see FIG. 15) of the slits 64 in the first light semi-transmitting region described in the first embodiment over the entire region. Specifically, the distribution density of the slits 164 at the center of the first light semi-transmitting region is lower than the distribution density of the slits 64 at the center of the first light semi-transmitting region described in the first embodiment, and a distribution density of the slits 164 at the outer peripheral end of the first light semi-transmitting region is lower than the distribution density of the slits 64 at the outer peripheral end of the first light semi-transmitting region described in the first embodiment. When a second flattening film 136 is exposed using such a photomask 160, an exposure amount of a portion of the second flattening film 136 overlapping the first light semi-transmitting region becomes smaller than the exposure amount in the first embodiment. As a result, the high level portion 144A provided by developing the second flattening film 136 is higher than the high level portion 44A described in the first embodiment.

As described above, according to the present embodiment, in the high level portion 144A, the height H101 from the opening edge of the opening 135A of the first flattening film 135 is larger than the film thickness of the alignment film 138. As described above, the height H101 of the high level portion 144A is larger than the film thickness of the alignment film 138, and thus when the alignment film 138 is formed, the material of the alignment film 138 is less likely to be present on the insulating portion 144, and a larger amount of the material of the alignment film 138 can be supplied to the position other than the insulating portion 144. As a result, the film thickness unevenness of the alignment film 138 is further less likely to occur at the position other than the position on the insulating portion 144.

### Third Embodiment

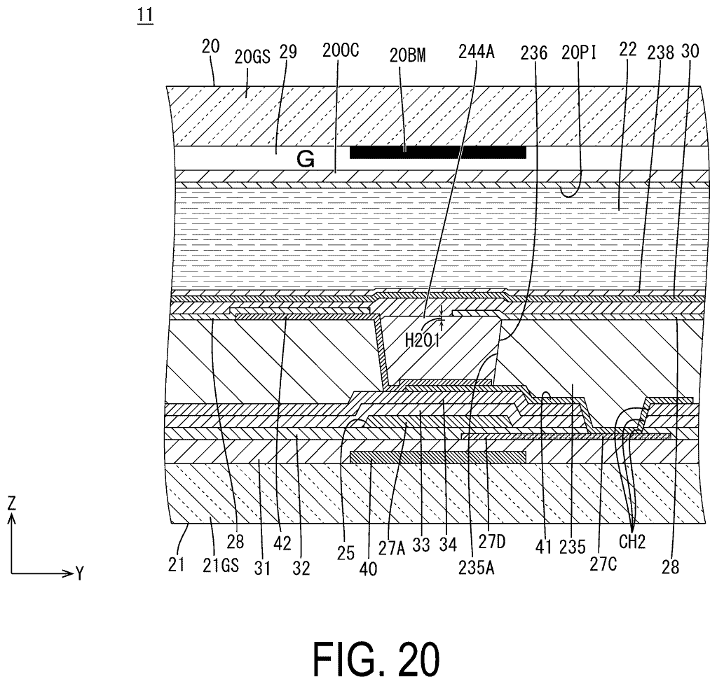

A third embodiment will be described with reference to FIGS. 20 to 22. In this third embodiment, an alternative configuration with a high level portion 244A changed from that of the first embodiment described above will be described. Further, repetitive descriptions of structures, actions, and effects similar to those of the first embodiment described above will be omitted.

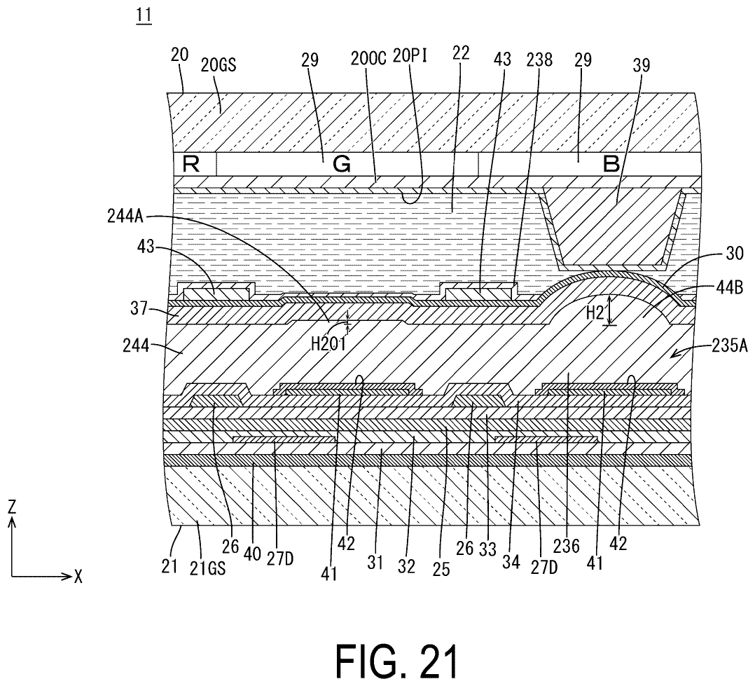

As illustrated in FIG. 20 and FIG. 21, an upper face of the high level portion 244A according to the present embodiment is a substantially flat plane. That is, in the high level portion 244A, a height H201 from an opening edge of an opening 235A in a first flattening film 235 is substantially constant. With this configuration, an alignment film 238 is flattened on an insulating portion 244, and in particular, a portion of the alignment film 238 overlapping the high level portion 244A is flattened. As in the first embodiment, in the high level portion 244A, the height H201 from the opening edge of the opening 235A of the first flattening film 235 is smaller than the film thickness of the alignment film 238. Thus, as in the first embodiment, the alignment film 238 is also present on the high level portion 244A without disconnected. The height H201 of the high level portion 244A is in a range, for example, from about 0.1 μm to about 0.5 μm.

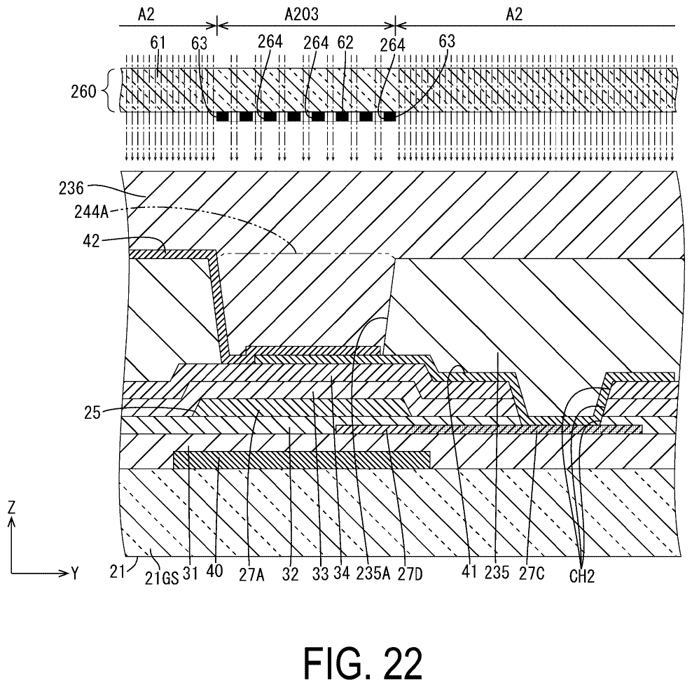

Next, a configuration of a photomask 260 used in the exposure step included in the thirteenth step of the array substrate manufacturing step will be described. As illustrated in FIG. 22, in the first light semi-transmitting region of a light semi-transmitting region A203 of the photomask 260, a distribution density of slits 264 is substantially constant over the entire region. Thus, in a portion of a second flattening film 236 overlapping the first light semi-transmitting region, the exposure amount is substantially constant over the entire region. As in the first embodiment, a distribution density of the slits 264 in the first light semi-transmitting region is lower than a distribution density of the slits 264 in the second light semi-transmitting region. When the second flattening film 236 is exposed using such a photomask 260, the exposure amount to a portion of the second flattening film 236 overlapping the first light semi-transmitting region is substantially constant over the entire region. As a result, in the high level portion 244A provided by developing the second flattening film 236, the height H201 is substantially constant and the upper face is a plane.

As described above, according to the present embodiment, the upper face of the high level portion 244A is a flat plane. With this configuration, the alignment film 238 is flattened on the insulating portion 244.

### Fourth Embodiment

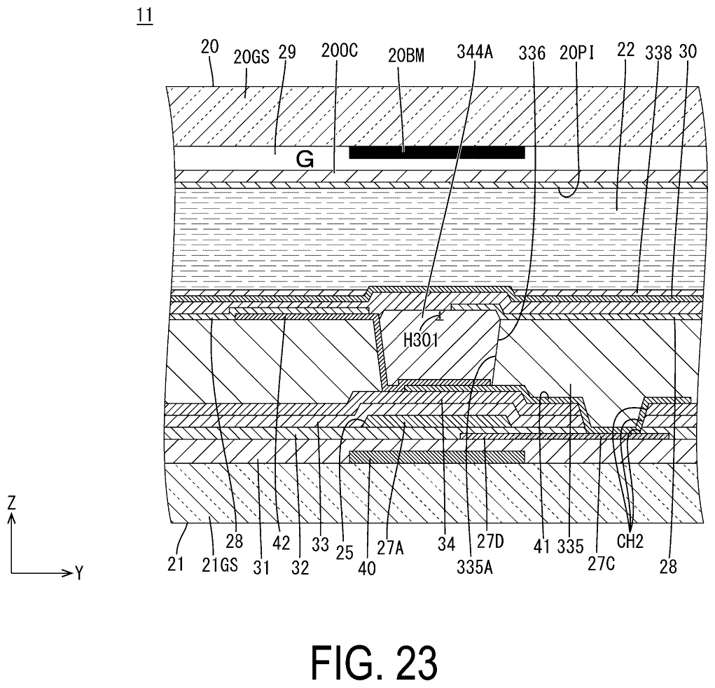

A fourth embodiment will be described with reference to FIGS. 23 to 25. In this fourth embodiment, an alternative configuration with an alignment film 338 and a high level portion 344A changed from that of the third embodiment described above will be described. Note that redundant descriptions of structures, actions, and effects similar to those of the third embodiment described above will be omitted.

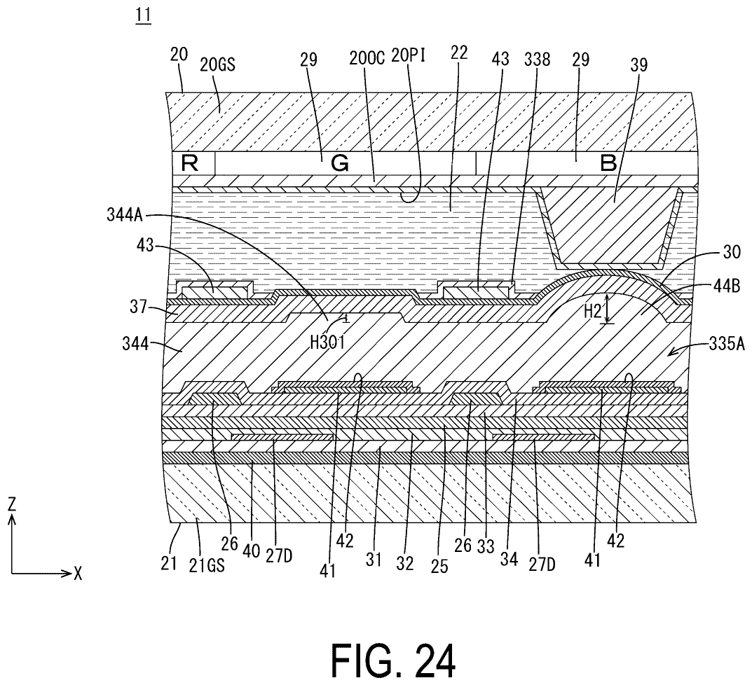

As illustrated in FIGS. 23 and 24, in the high level portion 344A according to the present embodiment, the height H301 from the opening edge of the opening 335A of the first flattening film 335 is larger than the height H201 (see FIG. 23) in the third embodiment and is larger than the film thickness of the alignment film 338. Thus, as in the second embodiment, the alignment film 338 is substantially not formed at a position overlapping the high level portion 344A in plan view. As a result, the film thickness unevenness of the alignment film 338 is further less likely to occur at a position other than a position on the insulating portion 344. Specifically, the height H301 of the high level portion 344A is in a range, for example, from about 0.1 μm to about 0.5 μm.

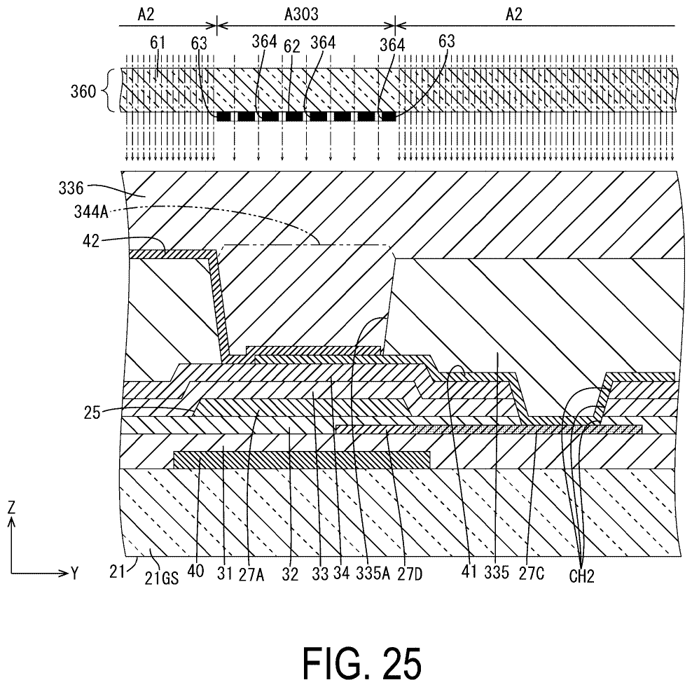

Next, a configuration of a photomask 360 used in the exposure step included in the thirteenth step of the array substrate manufacturing step will be described. As illustrated in FIG. 25, in the first light semi-transmitting region of a light semi-transmitting region A303 of the photomask 360, a distribution density of slits 364 is lower than the distribution density (see FIG. 22) of the slits 264 in the first light semi-transmitting region described in the third embodiment over the entire region. When a second flattening film 336 is exposed using such a photomask 360, an exposure amount of a portion of the second flattening film 336 overlapping the first light semi-transmitting region becomes smaller than the exposure amount in the third embodiment. As a result, the high level portion 344A provided by developing the second flattening film 336 is higher than the high level portion 244A described in the third embodiment.

### Fifth Embodiment

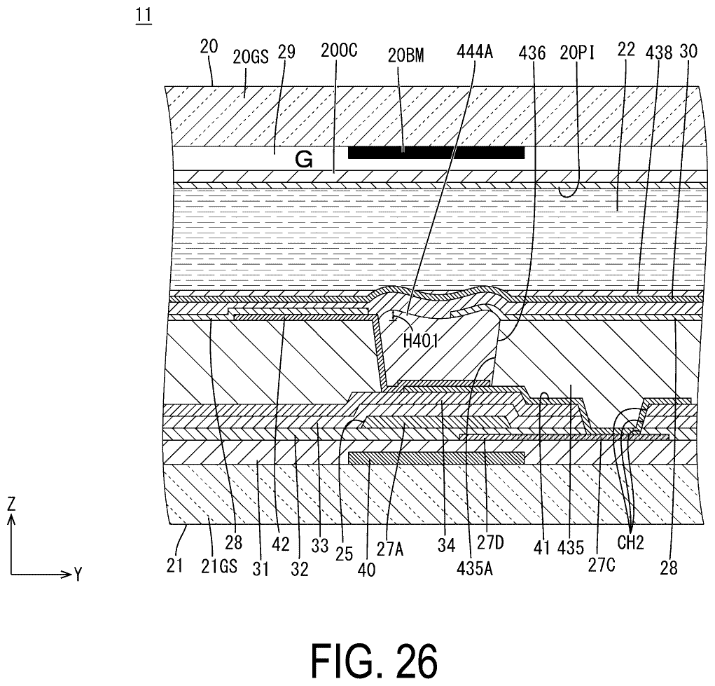

A fifth embodiment will be described with reference to FIGS. 26 to 28. In this fifth embodiment, an alternative configuration with a high level portion 444A changed from that of the second embodiment described above will be described. Further, repetitive descriptions of structures, actions, and effects similar to those of the second embodiment described above will be omitted.

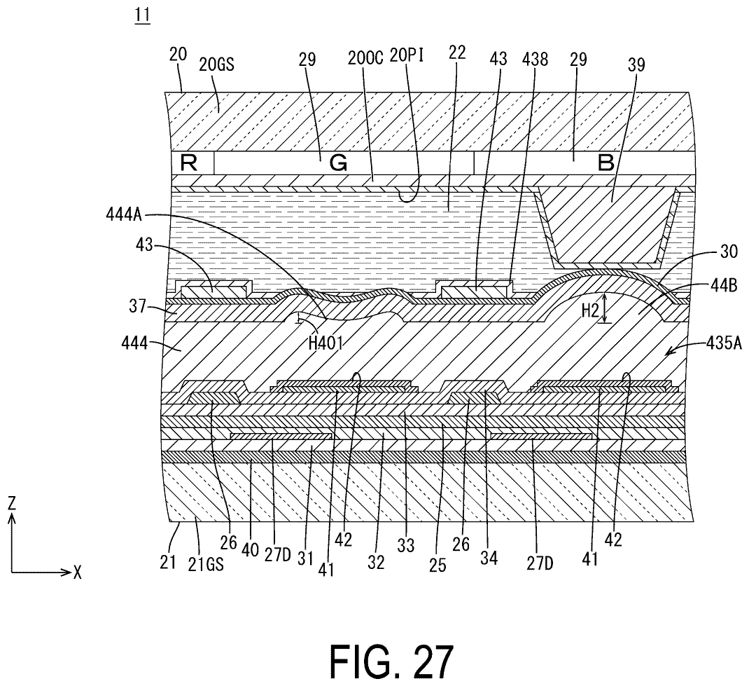

As illustrated in FIG. 26 and FIG. 27, the high level portion 444A according to the present embodiment is configured to be gradually higher from the center side toward the outer peripheral end side of the insulating portion 444. The high level portion 444A is configured to be lowest at a center position in plan view and highest at an outer peripheral end position. With this configuration, when the alignment film 38 is formed, the material of the alignment film 38 is likely to flow from the outer peripheral end side toward the center side of the insulating portion 44. As a result, the alignment film 438 is likely to remain on the center side of the insulating portion 444. In the high level portion 444A, the height H401 from an opening edge of an opening 435A of a first flattening film 435 is larger than the film thickness of the alignment film 438. The height H401 of the high level portion 444A is in a range, for example, from about 0.1 μm to about 0.5 μm. As described above, the height H401 of the high level portion 444A is larger than the film thickness of the alignment film 438, and thus when the alignment film 438 is formed, the material of the alignment film 438 is less likely to be present on the insulating portion 444. In the present embodiment, the alignment film 438 is substantially not formed at a position overlapping the high level portion 444A in plan view. As a result, a larger amount of the material of the alignment film 438 can be supplied to the position other than a position on the insulating portion 444, and thus the film thickness unevenness of the alignment film 438 is further less likely to occur at the position other than the position on the insulating portion 444.

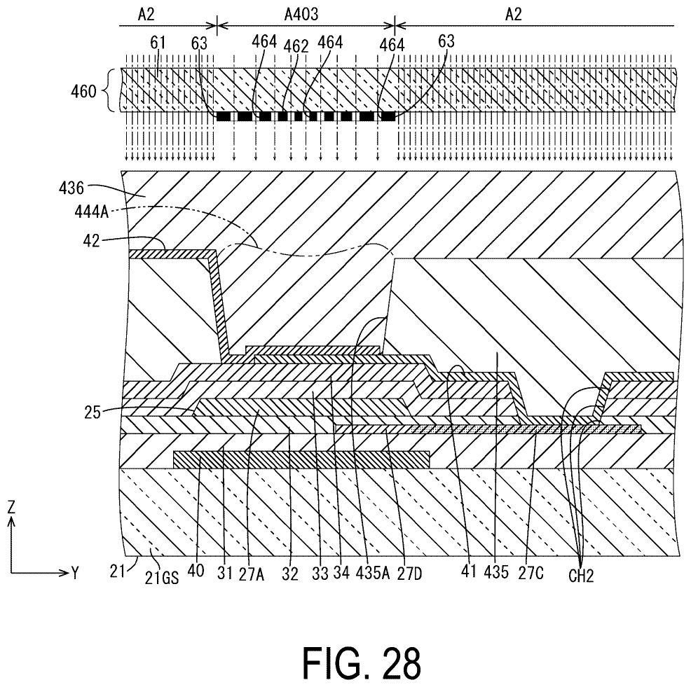

Next, a configuration of a photomask 460 used in the exposure step included in the thirteenth step of the array substrate manufacturing step will be described. As illustrated in FIG. 28, in the first light semi-transmitting region of a light semi-transmitting region A403 of the photomask 460, a distribution density of slits 464 is configured to be gradually lower from the outer peripheral end toward the center. In other words, the first light semi-transmitting region is configured such that a distribution density of a light blocking film 462 is gradually higher from the outer peripheral end toward the center. As a result, a transmitted light amount in the first light semi-transmitting region changes to gradually increase from the outer peripheral end toward the center. In the first light semi-transmitting region, the distribution density of the slits 464 is equal to the second embodiment described above, and is lower than the distribution density (see FIG. 15) of the slits 64 in the first light semi-transmitting region described in the first embodiment over the entire region. When the second flattening film 436 is exposed using the photomask 460 having such a configuration, in a portion of the second flattening film 436 overlapping the first light semi-transmitting region, the exposure amount changes to gradually increase from the outer peripheral end toward the center. When the second flattening film 436 is developed after the exposure step, the exposed portion of the second flattening film 436 is selectively removed in accordance with the exposure amount, and thus, as illustrated in FIG. 26 and FIG. 27, the insulating portion 444 including the high level portion 444A gradually higher from the center side toward the outer peripheral end side is provided.

As described above, according to the present embodiment, the high level portion 444A is configured to be gradually lower from the outer peripheral end side toward the center side of the insulating portion 444. With this configuration, the alignment film 438 is likely to remain on the center side of the insulating portion 444.

### Sixth Embodiment

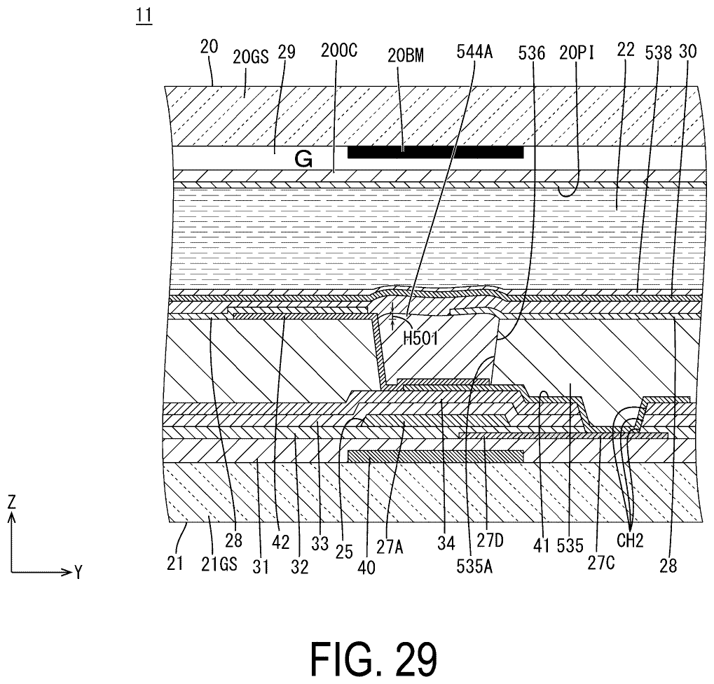

A sixth embodiment will be described with reference to FIGS. 29 to 31. In this sixth embodiment, an alternative configuration with a high level portion 544A changed from that of the fifth embodiment described above will be described. Further, repetitive descriptions of structures, actions, and effects similar to those of the fifth embodiment described above will be omitted.

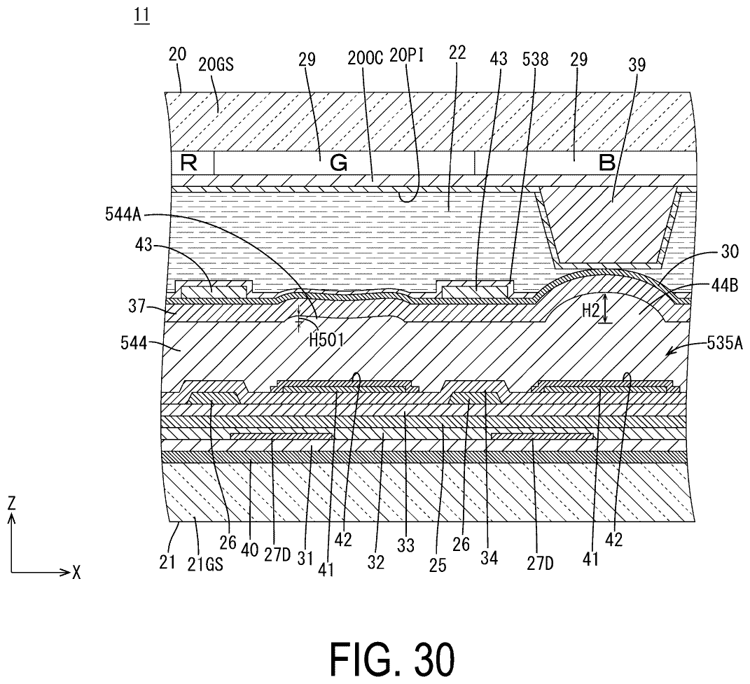

As illustrated in FIGS. 29 and 30, in the high level portion 544A according to the present embodiment, a height H501 from an opening edge of an opening 535A of a first flattening film 535 is smaller than the height H401 (see FIG. 26) in the fifth embodiment and is smaller than the film thickness of an alignment film 538. The height H501 of the high level portion 544A is in a range, for example, from about 0.1 μm to about 0.5 μm. Thus, as in the first and third embodiments, the alignment film 538 is also present on the high level portion 544A without disconnected.

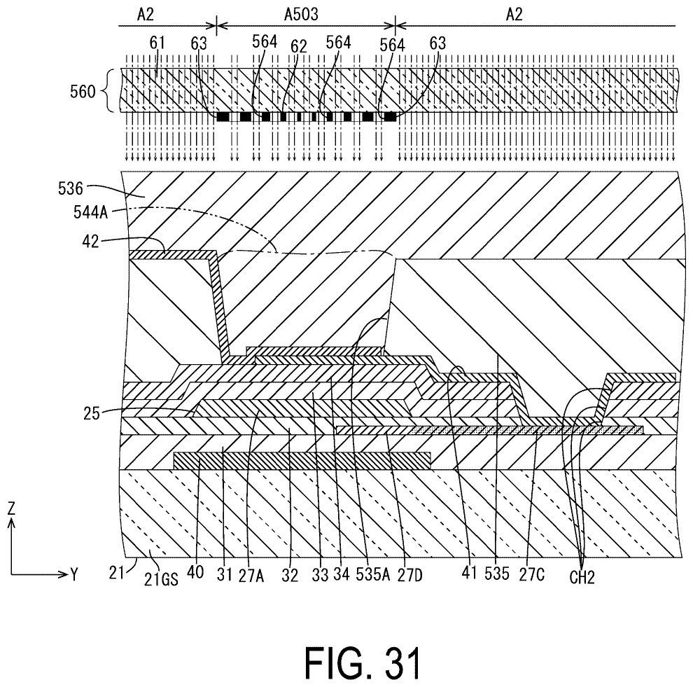

Next, a configuration of a photomask 560 used in the exposure step included in the thirteenth step of the array substrate manufacturing step will be described. As illustrated in FIG. 31, in the first light semi-transmitting region of a light semi-transmitting region A503 of the photomask 560, a distribution density of the slits 564 is higher than the distribution density (see FIG. 28) of the slits 464 in the first light semi-transmitting region described in the fifth embodiment over the entire region. Specifically, a distribution density of the slits 564 at the center of the first light semi-transmitting region is higher than the distribution density of the slits 464 at the center of the first light semi-transmitting region described in the fifth embodiment, and a distribution density of the slits 564 at the outer peripheral end of the first light semi-transmitting region is higher than the distribution density of the slits 464 at the outer peripheral end of the first light semi-transmitting region described in the fifth embodiment. When a second flattening film 536 is exposed using such a photomask 560, an exposure amount of a portion of the second flattening film 536 overlapping the first light semi-transmitting region is larger than the exposure amount in the fifth embodiment. As a result, the high level portion 544A provided by developing the second flattening film 536 is lower than the high level portion 444A described in the fifth embodiment.

### Other Embodiments

The techniques disclosed herein are not limited to the embodiments described above and illustrated in the drawings, and the following embodiments, for example, are also included within the technical scope.

(1) A specific numerical value of each of the heights of the high level portions 44A, 144A, 244A, 344A, 444A, and 544A and the bump 44B can be changed as appropriate in addition to the above.

(2) Each of the high level portions 44A, 144A, 244A, 344A, 444A, and 544A may be provided to form a linear shape extending along the X-axis direction in a respective one of the insulating portions 44, 144, 244, 344, and 444. The high level portions 44A, 144A, 244A, 344A, 444A, and 544A each having a linear shape in plan view may be arranged to extend over the plurality of first electrodes 41 and the plurality of second electrodes 42.

(3) The planar shape of each of the high level portions 44A, 144A, 244A, 344A, 444A, and 544A may be a triangle, a quadrangle, a polygon such as a pentagon having five or more sides, an ellipse, a semicircle, or the like in addition to a circle.

(4) The specific cross-sectional shape of each of the high level portions 44A, 144A, 244A, 344A, 444A, and 544A can be appropriately changed to shapes other than those illustrated.

(5) The number and the ratio of each of the high level portions 44A, 144A, 244A, 344A, 444A, and 544A and the bumps 44B to be provided can be appropriately changed to the number and the ratio other than those illustrated. For example, one bump 44B may be provided for every four or more pixels, or may be provided for every two or less pixels. In this case, the ratio of each of the high level portions 44A, 144A, 244A, 344A, 444A, and 544A to be provided may be changed to have an inverse correlation with the ratio of the bumps 44B to be provided.

(6) The insulating portions 44, 144, 244, 344, and 444 need not include the bump 44B. In this case, the bump 44B may include an insulating film (for example, the first flattening films 35, 135, 235, 335, 435, and 535) different from the second flattening films 36, 136, 236, 336, 436, and 536, respectively.

(7) Each of the openings 35A, 135A, 235A, 335A, 435A, and 535A is not limited to the configuration extending along the X-axis direction, and a plurality of each of the openings may be arranged side by side at intervals in the X-axis direction. In this case, each of the plurality of openings 35A, 135A, 235A, 335A, 435A, and 535A arranged at intervals in the X-axis direction may be individually provided for each of the first electrode 41 and the second electrode 42, or may be provided to cross the plurality of first electrodes 41 and the plurality of second electrodes 42.

(8) In the exposure step included in the thirteenth step, a halftone mask instead of the graytone mask may be used as the photomasks 60, 160, 260, 360, 460, and 560.

(9) An organic material having negative photosensitivity may be used as the material of the second flattening films 36, 136, 236, 336, 436, and 536.

(10) The first electrode 41 may be made of a metal film. In this case, instead of the first transparent electrode film, the metal film may be formed and patterned.

(11) The second electrode 42 may be made of a metal film. In this case, instead of the second transparent electrode film, the metal film may be formed and patterned.

(12) The second light blocking portion 43 may extend along the Y-axis direction overlapping substantially the entire length of the source wiring line 26.

(13) The counter-side light blocking portion 20BM of the counter substrate 20 may have a vertical stripe pattern overlapping the source wiring line 26. The counter-side light blocking portion 20BM of the counter substrate 20 may have a lattice shape overlapping both the gate wiring line 25 and the source wiring line 26.

(14) The color filter 29 may be provided on the array substrate 21. That is, the liquid crystal panel 11 may be a color filter on array (COA) structure.

(15) The number of colors of the color filter 29 may be four or more. The color filter 29 to be added may be a yellow color filter exhibiting yellow or a transparent color filter transmitting light of a full wavelength region, or the like.

(16) The configurations of the TFT 27 may be a bottom gate type, a double gate type, or the like, in addition to the top gate type illustrated in the drawings.

(17) The “upper layer electrode” that is the electrode among the pixel electrode 28 and the common electrode 30 located on the upper layer side may be the pixel electrode 28, and the “lower layer electrode” that is the electrode located on the lower layer side may be the common electrode 30. In this case, the pixel electrode 28 that is the “upper layer electrode” may be provided with a slit.

(18) The alignment films 38, 138, 238, 338, 438, and 538 may be subjected to alignment treatment through rubbing.

(19) The semiconductor film may be an amorphous silicon thin film or a polycrystalline silicon thin film.

(20) The display mode of the liquid crystal panel 11 may be a VA mode, an IPS mode or the like in addition to the FFS mode.

(21) The liquid crystal panel 11 may be a reflective type or a semi-transmissive type, in addition to a transmissive type. When the liquid crystal panel 11 is the reflective type, the backlight device 12 may be omitted.

(22) In addition to the head-mounted display 10HMD, the disclosure can be applied to, for example, a head-up display, a projector, or the like as a device that enlarges and displays an image displayed on the liquid crystal panel 11 using a lens or the like. The disclosure can be also applied to a display device that does not have an enlarged display function (a television receiver, a tablet terminal, a smartphone, or the like).

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. An array substrate comprising:
a first electrode;
a first insulating film disposed on an upper layer side of the first electrode, the first insulating film being provided with an opening at a position overlapping at least the first electrode;
a second electrode disposed on an upper layer side of the first insulating film, the second electrode overlapping the first electrode at least in the opening, and being connected to the first electrode;
a second insulating film disposed on an upper layer side of the second electrode; and
an alignment film disposed on an upper layer side than the second insulating film,
wherein the second insulating film includes an insulating portion provided in the opening, and
the insulating portion includes a high level portion higher than an opening edge of the opening of the first insulating film.

2. The array substrate according to claim 1,
wherein the first electrode and the second electrode include a plurality of first electrodes and a plurality of second electrodes disposed side by side at intervals in a first direction, and
each of the opening and the insulating portion extends along the first direction and is disposed to cross the plurality of first electrodes and the plurality of second electrodes.

3. The array substrate according to claim 2, further comprising
a first light blocking portion disposed on the lower layer side than the first electrode, the first light blocking portion being made of a light blocking material,
wherein the first light blocking portion extends along the first direction and is disposed overlapping the insulating portion.

4. The array substrate according to claim 2, further comprising
a plurality of second light blocking portions disposed on a lower layer side of the alignment film, the second light blocking portions being made of a light blocking material,
wherein the plurality of second light blocking portions are disposed side by side at intervals to interpose the first electrode and the second electrode in the first direction, and
the high level portion is disposed to be interposed between two of the second light blocking portions in the first direction.

5. The array substrate according to claim 1,
wherein a height of the high level portion from the opening edge of the opening of the first insulating film is larger than a film thickness of the alignment film.

6. The array substrate according to claim 1,
wherein a height of the high level portion from the opening edge of the opening of the first insulating film is smaller than a film thickness of the alignment film.

7. The array substrate according to claim 1,
wherein the high level portion is configured to be gradually higher from an outer peripheral end side toward a center side of the insulating portion.

8. The array substrate according to claim 1,
wherein an upper face of the high level portion is a plane.

9. The array substrate according to claim 1,
wherein the high level portion is configured to be gradually lower from an outer peripheral end side toward a center side of the insulating portion.

10. A liquid crystal display device comprising:
the array substrate according to claim 1;
a counter substrate disposed to face the array substrate; and
a liquid crystal layer disposed between the array substrate and the counter substrate.

11. The liquid crystal display device according to claim 10,
wherein the counter substrate is provided with a spacer protruding toward the array substrate,
the first electrode and the second electrode include a plurality of first electrodes and a plurality of second electrodes disposed side by side at intervals in a first direction,
each of the opening and the insulating portion extends in the first direction and is disposed to cross the plurality of first electrodes and the plurality of second electrodes, and
the insulating portion includes a bump higher than the opening edge of the opening of the first insulating film and disposed overlapping the spacer.

12. The liquid crystal display device according to claim 11,
wherein the high level portion is lower than the bump.
